(19) United States
(12) Patent Application Publication
(10) Pub. No.: US 2025/0166876 A1
(43) Pub. Date: May 22, 2025

(54) INDUCTOR AND MANUFACTURING METHOD THEREFOR

(71) Applicant: POINT ENGINEERING CO., LTD., Chungcheongnam-do (KR)

(72) Inventors: Bum Mo AHN, Gyeonggi-do (KR); Seung Ho PARK, Gyeonggi-do (KR); Tae Hwan SONG, Gyeonggi-do (KR)

(73) Assignee: POINT ENGINEERING CO., LTD., Chungcheongnam-do (KR)

(21) Appl. No.: 18/840,071

(22) PCT Filed: Feb. 16, 2023
(86) PCT No.: PCT/KR2023/002306

§ 371 Date: Aug. 20, 2024

(30) Foreign Application Priority Data
Feb. 23, 2022 (KR) 10-2022-0023606

(51) Int. Cl. H01F 5/02; H01F 41/06

(52) U.S. Cl. CPC H01F 5/02; H01F 41/06

(57) ABSTRACT

The present invention relates to an inductor and a manufacturing method therefor, and, particularly, the objective of the present invention is to provide an inductor and a manufacturing method therefor, the inductor satisfying needs of small size and low resistance and, simultaneously, having a simplified manufacturing process such that mass production thereof is possible.

### TECHNICAL FIELD

The present disclosure relates to an inductor and a method for manufacturing the same.

### BACKGROUND ART

Inductors are passive components that use electromagnetic action generated by passing current through a conducting wire wound around a core. Such inductors are being developed into various products for high-frequency circuits, general circuits, decoupling circuits, and power circuits.

There are variable inductors with variable inductance, but most are fixed inductors. The inductors are provided as a lead type and a surface-mount type and structurally classified into a wire-wound type, a laminated type, and a thin type.

The inductors may be combined with capacitors to form resonant circuits, and may be used in filter circuits to filter specific signals or used for impedance matching.

Recently, as electronic and communication devices have been developed, environmental problems and communication failures may occur. Accordingly, technology is advancing in terms of functional complexity, high integration, and high efficiency.

Acceleration of miniaturization and high performance of electronic and communication devices requires miniaturization and suppression of heat generation by low resistance for components or devices used. Accordingly, research is needed to miniaturize and reduce resistance of the inductors used in electronic and communication devices.

The wound type inductor currently developed is manufactured through a process of forming a coil element part by winding a conducting wire while heat-bonding the wire to maintain a wound shape of the wire, mounting a coil element part to a magnetic core in a form of a slurry, and then pressing and hardening the magnetic core.

The thin type inductor is manufactured through a process of preparing a support member, forming conductive layers on an upper surface and a lower surface of the support member, patterning a coil pattern, stacking a magnetic sheet at the upper part of the coil pattern, pressing and hardening it to form a magnetic body.

The laminated type inductor is manufactured through a process of forming a via by punching a ceramic sheet by using a laser, laminating multiple layers of ceramic sheets with a conductive pattern printed with a conductive metal to fill the via, and then sintering and integrating the ceramic sheets.

However, the structures of the inductors manufactured through the above manufacturing process have limitations in satisfying the needs for miniaturization and low resistance demanded by the market, and it is difficult to achieve mass production due to the complex manufacturing processes thereof.

### DOCUMENTS OF RELATED ART

### Patent Document

(Patent Document 1) Korean Application Publication No. 10-2020-0115286

(Patent Document 2) Korean Patent No. 10-2093558

### SUMMARY OF INVENTION

### Technical Problem

Accordingly, the present disclosure has been made keeping in mind the above problems occurring in the related art, and an objective of the present disclosure is to provide an mass-producible inductor and a method for manufacturing the same by satisfying needs of miniaturization and low resistance and simplifying a manufacturing process thereof.

### Technical Solution

To achieve the above-described objectives of the present disclosure, there is provided an inductor according to the present disclosure, the inductor including: a body of an anodic oxidation film material; a coil unit including a plurality of vertical connection parts passing through the body, and horizontal connection parts connecting the plurality of vertical connection parts; and a through hole formed through an upper surface and a lower surface of the body to be located inside the plurality of vertical connection parts.

Furthermore, the horizontal connection parts may include: first horizontal connection parts provided above the body and connecting upper surfaces of the plurality of vertical connection parts to each other; and second horizontal connection parts provided below the body and connecting lower surfaces of the plurality of vertical connection parts to each other, and the through hole may be located between the first and second horizontal connection parts.

Furthermore, the inductor may further include: a first passivation layer located above the through hole and below each first horizontal connection part to support each first horizontal connection part; and a second passivation layer located below the through hole and above each second horizontal connection part to support each second horizontal connection part.

Furthermore, the first passivation layer may include a plurality of first passivation layers as the same number as the number of the plurality of first horizontal connection parts, and the plurality of first passivation layers may be located respectively below the plurality of first horizontal connection parts, and the second passivation layer may be formed to have an area wider than an area of the through hole to block a lower portion of the through hole and be located above the plurality of second horizontal connection parts.

Furthermore, the vertical connection parts may include: first vertical connection parts arranged in a column direction at a first part of the body; and second vertical connection parts arranged in the column direction at a second part of the body, and when the first vertical connection parts are projected toward the second vertical connection parts, the first vertical connection parts may be located between the second vertical connection parts.

Furthermore, each of the horizontal connection parts may connect one of the plurality of the first vertical connection parts to one of the second vertical connection parts, the second vertical connection part being located at a minimum distance.

Furthermore, the inductor may further include: a filler of a low dielectric permittivity material, the filler being filled inside the through hole.

Furthermore, the inductor may further include: a filler of a high permeable magnetic material, the filler being filled inside the through hole.

To achieve the above-described objectives of the present disclosure, there is provided a method for manufacturing an inductor, the method including: preparing a body of an anodic oxidation film material; forming vertical through parts, wherein a plurality of first vertical through parts is formed at a first side of the body and formed through upper and lower surfaces of the body and arranged in a column direction, and a plurality of second vertical through parts is formed at a second side of the body and formed through the upper and lower surfaces of the body and arranged in the column direction; forming vertical connection parts, wherein electrically conductive materials are filled into the plurality of first vertical through parts and the plurality of second vertical through parts to form a plurality of first vertical connection parts and a plurality of second vertical connection parts; forming horizontal connection parts, wherein a plurality of first horizontal connection parts is formed above the body and connect upper surfaces of the plurality of first vertical connection parts to upper surfaces of the plurality of second vertical connection parts, and a plurality of second horizontal connection parts is formed below the body and connect lower surfaces of the plurality of first vertical connection parts and lower surfaces of the plurality of second vertical connection parts; and forming a through hole, wherein the through hole is formed through the upper and lower surfaces of the body to be located inside the first and second vertical connection parts.

Furthermore, the method may further include: forming passivation layers, before the forming of the first and second horizontal connection parts, wherein a first passivation layer may be formed above the body and a second passivation layer may be formed below the body, wherein in the forming of the horizontal connection parts, each first horizontal connection part may be formed above the first passivation layer, and each second horizontal connection part may be formed below the second passivation layer.

Furthermore, the method may further include: filling a filler inside the through hole, after the forming of the through hole.

### Advantageous Effects

As described above, the inductor the present disclosure and the method for manufacturing the same may have the following effects.

Through the body made of an anodic oxidation film material, it is possible to form the vertical connection parts 210 and the horizontal connection parts 230 with the same widths or areas, and a stable current flow can be secured.

Furthermore, thermal deformation of the inductor can be minimized, so coil breakage of the coil unit or change of inductance can be prevented.

Furthermore, heat stress does not occur because the vertical through part is formed by wet etching and it is possible to form the vertical through part more tightly. Therefore, the width of the vertical connection part can be reduced and inductance of the inductor can be significantly improved.

Since the passivation layer supports the horizontal connection part, it is possible to prevent the coil unit from being damaged due to damage to the horizontal connection part.

Air or a filler of a low dielectric permittivity material inside the through hole can minimize loss to secure a high quality factor of the inductor.

A filler of high permeable magnetic material inside the through hole may secure a high inductance of the inductor.

### DESCRIPTION OF DRAWINGS

FIG. 1 is a view showing an inductor according to a first embodiment of the present disclosure.

FIGS. 2a to 6b are views showing a manufacturing process of the inductor according to the first embodiment of the present disclosure.

FIG. 7 is a schematic diagram showing the manufacturing process of the inductor according to the first embodiment of the present disclosure.

FIG. 8 is a view showing an inductor according to a second embodiment of the present disclosure.

FIGS. 9a to 14b are views showing a manufacturing method of the inductor according to the second embodiment of the present disclosure.

FIG. 15 is a schematic diagram showing the manufacturing process of the inductor according to the second embodiment of the present disclosure.

FIG. 16 is a view showing an inductor according to a third embodiment of the present disclosure.

FIGS. 17a to 22b are views showing a manufacturing method of the inductor according to the third embodiment of the present disclosure.

FIG. 23 is a schematic diagram showing the manufacturing process of the inductor according to the third embodiment of the present disclosure.

FIG. 24a is a plan view showing an inductor according to a fourth embodiment of the present disclosure.

FIG. 24b is a sectional view showing the inductor according to the fourth embodiment of the present disclosure, which is taken along the line A-A′ of FIG. 24a.

FIG. 25 is a schematic diagram showing the manufacturing process of the inductor according to the fourth embodiment of the present disclosure.

FIG. 26a is a plan view showing an inductor according to a fifth embodiment of the present disclosure.

FIG. 26b is a sectional view showing the inductor according to the fifth embodiment of the present disclosure, which is taken along the line A-A′ of FIG. 26a.

### MODE FOR INVENTION

Hereinbelow, the following illustrates the principle of the present disclosure. Those skilled in the art will be able to embody the principle of the present disclosure and invent various apparatuses included in the spirit and the scope of the present disclosure, although not shown herein. Furthermore, all conditional terms and embodiments described herein are clearly intended for the purpose of understanding the concept of the present disclosure, and should be understood not to be limited to the specifically listed embodiments and states.

The above and other objectives, features and advantages of the present disclosure will be more clearly understood from the following detailed description taken in conjunction with the accompanying drawings.

The embodiments described herein will be described with reference to sectional views and/or perspective views, which are ideal drawings of the present disclosure. The thicknesses of films and regions illustrated in the drawings are exaggerated for an effective description of the technical sprit of the present disclosure. Variations from the shapes of the illustrations as a result, for example, of manufacturing techniques and/or tolerances, are to be expected. Furthermore, the number of moldings illustrated in the drawings is illustrative, and only a part of the entire moldings. Therefore, the embodiments of the present disclosure are not limited to the specific forms shown in the drawings, but include the changes in the forms caused by manufacturing processes.

In describing various embodiments, the same names and the same reference numbers will be used to refer to components that perform the same function even when the embodiments are different. Furthermore, configuration and operation already described in other embodiments will be omitted for convenience.

### Inductor 10 According to the First Embodiment of the Present Disclosure and Method for Manufacturing Inductor 10

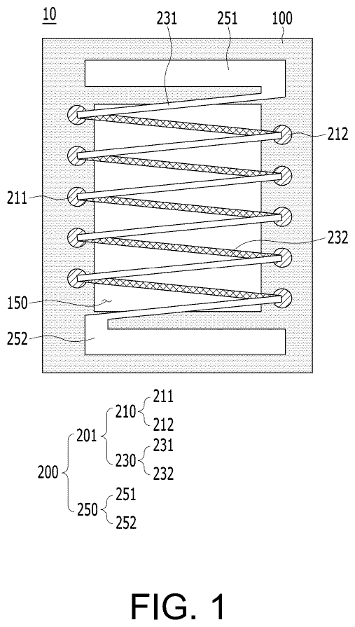

Hereinbelow, an inductor 10 according to the first embodiment of the present disclosure and a method for manufacturing the inductor 10 will be described with reference to FIGS. 1 to 7.

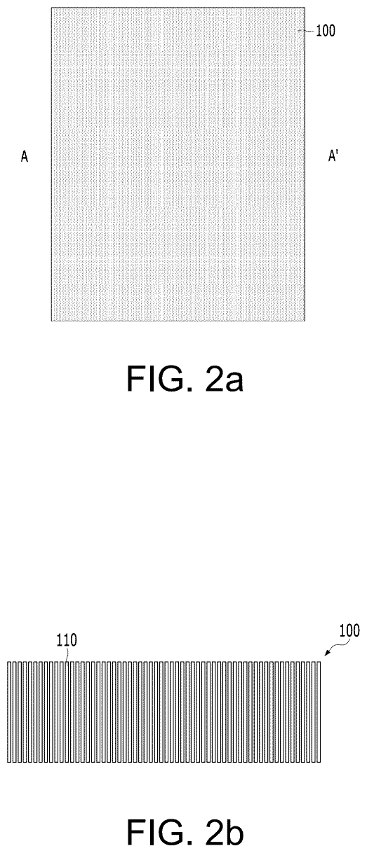

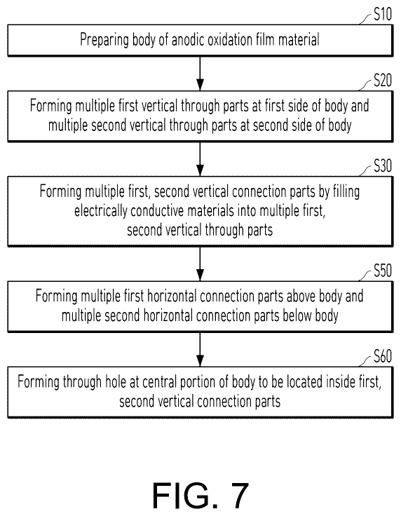

FIG. 1 is a view showing an inductor according to a first embodiment of the present disclosure. FIGS. 2a to 6b are views showing a manufacturing process of the inductor according to the first embodiment of the present disclosure. FIG. 7 is a schematic diagram showing the manufacturing process of the inductor according to the first embodiment of the present disclosure.

In the plan views of FIGS. 1, 2a, 3a, 4a, 5a, and 6a, an upward direction is the front side of the inductor 10, and a downward direction is the rear side of the inductor 10.

Referring to FIGS. 1 to 6b, the inductor 10 according to the first embodiment of the present disclosure may include a body 100 of an anodic oxidation film material; a coil unit 200 including a plurality of vertical connection parts 210 formed through the body 100 and a horizontal connection part 230 connecting one to another of the plurality of the vertical connection parts 210; and a through hole 150 formed through upper and lower surfaces of the body to be located inside the plurality of vertical connection parts 210.

The body 100 is made of an anodic oxidation film material.

An anodic oxidation film may be a film formed by anodizing a parent metal.

Each pore 110 is a hole formed during a process of forming an anodic oxidation film by anodizing a metal. Each pore 110 is formed to have a diameter of several nanometers to hundreds of nanometers.

For example, when a parent metal is aluminum (Al) or an aluminum alloy, when a parent

metal is anodized, an anodic oxide film of aluminum oxide film (Al203) material is formed on a surface of the parent metal. The anodic oxide film formed as described above is vertically divided into a barrier layer in which pores 110 are not formed, and a porous layer in which the pores are formed. When the parent metal is removed from the parent metal on which the anodic oxide film with the barrier layer and the porous layer is formed on the surface thereof, only the anodic oxide film of aluminum oxide (Al203) material remains.

The anodic oxide film may be formed into a penetrated structure formed vertically through each pore without the barrier layer formed during anodizing or a structure in which the barrier layer formed during anodizing remains and blocks either of upper or lower end portion of each pore.

The anodic oxide film has a thermal expansion coefficient of 2˜3 ppm/° C. Accordingly, when the anodic oxide is exposed to a high-temperature environment, the thermal deformation due to the temperature is less.

The inductor 10 according to the first embodiment of the present disclosure will be described based on, as one example, the body 100 having a structure that is vertically penetrated through each pore 110 without the barrier layer formed during the anodizing.

The coil unit 200 may include the plurality of vertical connection parts 210 formed through the body 100 and the horizontal connection part 230 connecting one to another of the plurality of vertical connection parts 210.

The coil unit 200 consists of electrically conductive materials and may be preferably formed by including metals with high electrical conductivity. For example, materials constituting the coil unit 200 include silver (Ag), palladium (Pd), aluminum (Al), nickel (Ni), titanium (Ti), gold (Au), copper (Cu), platinum (Pt), or an alloy thereof.

The coil unit 200 includes a winding part 201 and a pad part 250. The pad part 250 includes a first pad part 251 connected to a first end of the winding part 201 and a second pad part 253 connected to a second end of the winding part 201.

The winding part 201 is formed between the first and second pad parts 251 and 253. The first pad part 251 is formed at an upper surface of the body 100.

The first pad part 251 is located at a front portion of the body 100 on the upper surface of the body 100, i.e., a front portion of the inductor 10, to be connected to a first horizontal connection part 231 located at the frontmost position among a plurality of first horizontal connection parts 231 and to a second horizontal connection part 232 located at the frontmost position among second horizontal connection parts 232.

The second pad part 252 is formed at the upper surface of the body 100.

The second pad part 252 is located at a rear portion of the body 100 on the upper surface of the body 100, i.e., a rear portion of the inductor 10, to be connected to a first horizontal connection part 231 located at the rearmost position among the plurality of first horizontal connection parts 231 and a second horizontal connection part 232 located at the rearmost position among the second horizontal connection parts 232.

The first pad part 251 is connected to a first external electrode (not shown), and the second pad part 253 is connected to a second external electrode (not shown).

The first and second external electrodes (not shown) are made of materials of copper (Cu), nickel (Ni), tin (Sn), or an alloy thereof. The first and second pad parts 251 and 253 may be provided at the same surface of the body 100, e.g., all pad parts may be provided on the upper surface of the body. However, the present disclosure is not limited thereto.

The winding part 201 includes the plurality of vertical connection parts 210 formed through the body 100 and the horizontal connection parts 230 connecting the vertical connection parts 210 to each other.

The winding part 201 is formed to be wound around a partial region of the body 100 with the horizontal connection parts 230 provided outside the body 100 and the vertical connection parts 210 provided inside the body 100.

The vertical connection parts 210 are formed by filling an electrically conductive material into vertical through parts 130 formed through the upper and lower surfaces of the body 100.

The horizontal connection parts 230 are provided at a surface of the body 100, are made of an electrically conductive material, and may be the same material as the vertical connection parts 210.

The horizontal connection parts 230 may include the first horizontal connection parts 231 provided above the body 100 and connecting upper surfaces of the plurality of vertical connection parts 210 to each other, and the second horizontal connection parts 232 provided below the body 100 and connecting lower surfaces of the plurality of vertical connection parts 210 to each other.

The vertical connection parts 210 may include first vertical connection parts 211 arranged in a column direction at a first part of the body 100; and second vertical connection parts 212 arranged in the column direction at a second part of the body 100.

As one example, in FIG. 1, the plurality of first vertical connection parts 211 is arranged in the column direction at the left part of the body 100, and the plurality of second vertical connection parts 212 is arranged in the column direction at the right part of the body 100.

The first and second horizontal connection parts 231 and 232 are provided at surfaces of the body 100, consist of electrically conductive materials, and may be the same material as the first and second vertical connection parts 211 and 212.

The plurality of first vertical connection parts 211 and the plurality of second vertical connection parts 212 arranged in the column direction are arranged to be spaced apart from each other by predetermined distances.

Each of the first horizontal connection parts 231 connects one of the plurality of first vertical connection parts 211 to one of the plurality of second vertical connection parts 212 which is located at the minimum distance.

The first horizontal connection parts 231 may be provided in a diagonal direction having rightward-upward inclination based on FIG. 1.

The vertical connection parts 210 arranged in the column direction, i.e., the first and second vertical connection parts 211 and 212 are arranged to be spaced apart from each other by predetermined distances. Therefore, the first horizontal connection parts 231 may have the inclination of the same angle.

Each of the second horizontal connection parts 232 connects one of the plurality of second vertical connection parts 212 to one of the plurality of first vertical connection parts 211 which is located at the minimum distance.

The second horizontal connection parts 232 may be provided in a diagonal direction having a leftward-upward inclination based on FIG. 1. The second horizontal connection parts 232 may have the inclination of the same angle.

Each first horizontal connection part 231 may connect the upper surface of each first vertical connection part 211 to the upper surface of each second vertical connection part 212. Therefore, each first horizontal connection part 231 connects the upper surface of one of the plurality of first vertical connection parts 211 to the upper surface of one of the plurality of second vertical connection parts 212 which is located at the minimum distance. Furthermore, each of the second horizontal connection parts 232 connects the lower surface of one of the plurality of second vertical connection parts 212 to the lower surface of one of the plurality of first vertical connection parts 211 which is located at the minimum distance.

The through hole 150 is provided below the first horizontal connection parts 231, and a part of the first horizontal connection parts 231 has a form that crosses an upper portion of the through hole 150.

The through hole 150 is provided above the second horizontal connection parts 232, and a part of the second horizontal connection parts 232 has a form that crosses a lower part of the through hole 150.

In other words, the winding part 201 is formed with the first horizontal connection parts 231 crossing the upper part of the through hole 150 and the second horizontal connection parts 232 crossing the lower part of the through hole 150.

While the first horizontal connection parts 231 and the second horizontal connection parts 232 are connected to each other through the vertical connection parts 210, the form is provided such that a coil is entirely wound by penetrating the body 100 through the vertical connection parts 210. An inner region of the coil unit 200 formed by the first and second vertical connection parts 211 and 212 and the first and second horizontal connection parts 231 and 232 has a quadrangle section.

When the plurality of first vertical connection parts 211 is projected toward the plurality of second vertical connection parts 212, the plurality of first vertical connection parts 211 is located between the plurality of second vertical connection parts 212.

When two adjacent first vertical connection parts 211 of the first vertical connection parts 211 are projected toward the second vertical connection parts 212 and imaginary lines connecting the first vertical connection parts 211 to a second vertical connection part 212 located therebetween are drawn, the imaginary lines are hypotenuses of an isosceles triangle. Accordingly, more stable inductance may be obtained by minimizing a difference in a direction of magnetic flux generated by the second horizontal connection parts 232 and a direction of magnetic flux generated by the first horizontal connection parts 231.

Furthermore, a length of each first horizontal connection part 231 and a length of each second horizontal connection part 232 are formed equally, so a time in which a current flows along the first horizontal connection part 231 and a time in which a current flows along the second horizontal connection part 232 are equalized and stable inductance may be obtained.

The through hole 150 is formed through the upper and lower surface of the body 100 to be located inside the plurality of vertical connection parts 210. The through hole 150 is provided inside the coil unit 200. In other words, the through hole 150 is located inward of the coil unit 200.

The inner portion of the through hole 150 is filled with air. An dielectric permittivity of air is about 1, and has a low dielectric permittivity. In other words, air is a material with a low dielectric permittivity.

When a low dielectric permittivity material is provided in the coil unit 200, magnetic permeability is low and a high inductance value cannot be obtained, but a loss is relatively small, so a high quality factor value may be obtained in a high frequency.

As described above, the inductor 10 according to the first embodiment of the present disclosure serves as a dielectric inductor having a high quality factor value by air inside the through hole 150.

Hereinbelow, a method for manufacturing the inductor 10 according to the first embodiment of the present disclosure will be described.

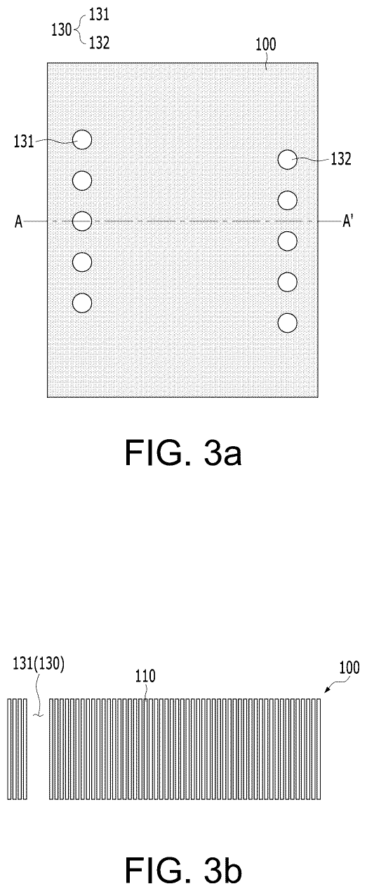

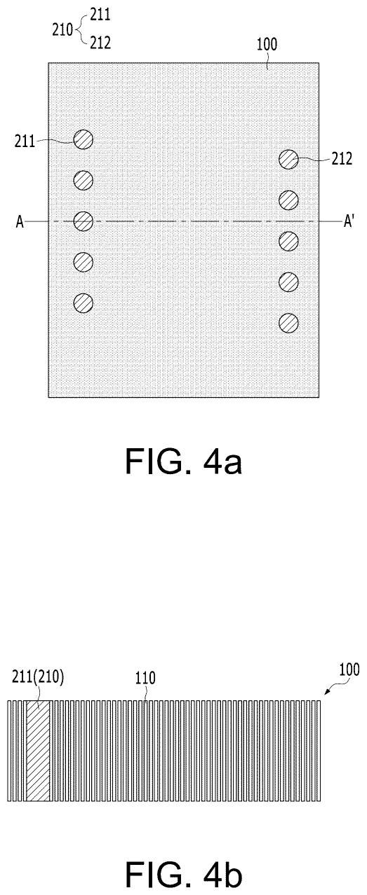

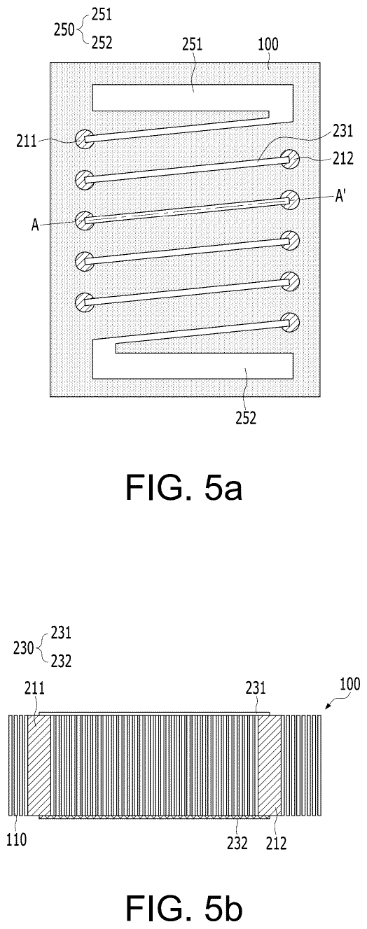

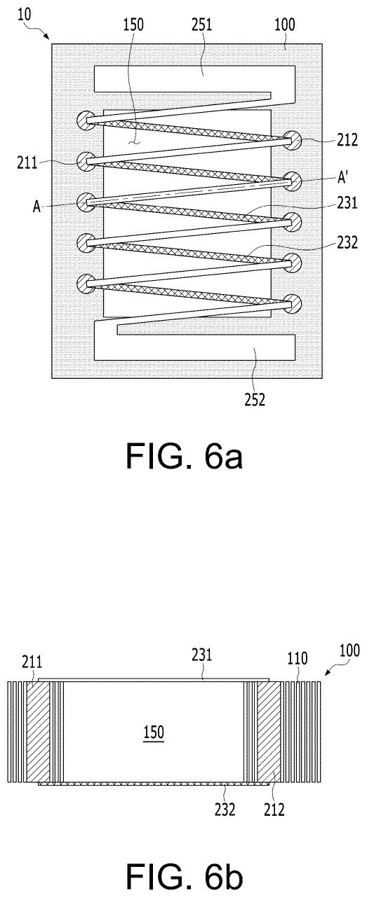

FIG. 2a is a plan view of the body of an anodic oxidation film material. FIG. 2b is a sectional view of the body, which is taken along the line A-A′ of FIG. 2a. FIG. 3a is a plan view of the body in which the first and second vertical through parts are formed. FIG. 3b is a sectional view of the body, which is taken along the line A-A′ of FIG. 3a. FIG. 4a is a plan view of the body in which the first and second vertical connection parts are formed. FIG. 4b is a sectional view of the body, which is taken along the line A-A′ of FIG. 4a. FIG. 5a is a plan view of the body in which the first and second horizontal connection parts and the first and second pad parts are formed. FIG. 5b is a sectional view of the body, which is taken along the line A-A′ of FIG. 5a. FIG. 6a is a plan view of the body in which the through hole is formed. FIG. 6b is a sectional view of the body, which is taken along the line A-A′ of FIG. 6a.

As shown in FIGS. 1 to 7, the method for manufacturing the inductor 10 according to the first embodiment of the present disclosure may include: preparing the body 100 of an anodic oxidation film material, S10; forming the vertical through parts S20, in which the plurality of first vertical through parts 131 is formed at a first side of the body 100 and through the upper and lower surfaces of the body 100 and arranged in a column direction, and the plurality of second vertical through parts 132 is formed at a second part of the body 100 and through the upper and lower surfaces of the body 100 and arranged in a column direction; forming the vertical connection parts S30, in which the plurality of first, second vertical through parts 131, 132 is filled with an electrically conductive material to form the plurality of first, second vertical connection parts 211, 212; forming the horizontal connection parts S50, in which the plurality of first horizontal connection parts 231 is formed to be located above the body 100 and connect the upper surfaces of the plurality of first vertical connection parts 211 to the upper surfaces of the plurality of second vertical connection parts 212, and the plurality of second horizontal connection parts 232 is formed to be located below the body 100 and connect the lower surfaces of the plurality of first vertical connection parts 211 to the lower surfaces of the plurality of second vertical connection parts 212; and forming the through hole S60, in which the through hole 150 is formed through the upper and lower surfaces of the body 100 to be located inside the plurality of first, second vertical connection parts 211, 212.

As described above FIGS. 2a and 2b, in the preparing of the body S10, the process of

preparing the body 100 of an anodic oxidation film material is performed.

When the anodic oxidation film is formed after a parent metal is anodized, the pores 110 are formed, and then the parent metal is removed to produce the body 100 consisting of only the anodic oxidation film.

Thereafter, the barrier layer is removed until only the porous layer with the pores 110 remain.

The anodic oxidation film material only remains in the body 100 with the barrier layer removed, and the plurality of pores 110 is provided. The plurality of pores 110 penetrates through the upper surface and the lower surface of the body 100 to form the porous layer.

As described above, when the body 100 is prepared, the preparing S10 of the body is completed.

After the preparing S10 is completed, the forming S20 of the vertical through parts is formed.

As shown in FIGS. 3a and 3b, the forming S20 of the vertical through parts is performed by forming the plurality of first vertical through parts 131 provided at the first part of the body 100 and formed through the upper and lower surfaces of the body 100 and arranged in the column direction, and forming the plurality of second vertical through parts 132 provided at the second part of the body 100 and formed through the upper and lower surfaces of the body 100 and arranged in the column direction.

As shown in FIG. 3a, the plurality of first vertical through parts 131 is formed at the left part of the body 100, and the plurality of second vertical through parts 132 is formed at the right part of the body 100.

As the body 100 is made of an anodic oxidation film material, the first, second vertical through parts 131, 132 may be easily formed.

In describing in detail, as the related art, a laser is used to form the vertical through parts in the body, the vertical through parts formed by the laser are not formed vertically and a current flow of the coil unit of the inductor is not stable, which is problematic. In addition, cracks easily occur in surrounding areas of the vertical through parts due to heat stress caused by the laser and the vertical through parts cannot be formed tightly, which is problematic.

However, in the inductor 10 according to the first embodiment of the present disclosure, since the body 100 is made of an anodic oxidation film material, wet etching is performed using a photoresist patterned on the body 100 made of the anodic oxidation film to form the vertical through parts 130, i.e., the first, second vertical through parts 131, 132. Accordingly, inner walls of the vertical through parts 130, i.e., the first, second vertical through parts 131, 132 are formed vertically. In other words, it is possible for sectional areas of the inner walls of the vertical through parts 130 to be the same from lower parts to upper parts of the vertical through parts 130. Therefore, the current flow of the coil unit 200 is stable.

Furthermore, heat stress does not occur because the vertical through parts 130 are formed by wet etching and it is possible to form the vertical through parts 130 more tightly.

For example, when the width of each vertical connection part 210 is reduced to ½, the number of windings of the coil unit 200 may be doubled, and as a result, inductance of the inductor 10 may be multiplied by four.

In the case of the inductor 10 according to the first embodiment of the present disclosure, when a material of the body 100 is an anodic oxidation film material, the width of each vertical connection part 210 may be reduced and inductance of the inductor 10 may be largely increased.

As described above, when a laser is used as the related art, there is a limit in reducing the width of each vertical through part. Specifically, when the thickness of the body 100 is formed 100 μm or more, it is difficult to make the width of each vertical through part 130 formed using the laser equal to or less than 10 μm. Even if it is possible to make the width of each vertical through part 130 equal to or less than 10 μm, the inner walls of the vertical through parts 130 are not formed vertically and a section with a small width occurs inside each vertical through part 130, which is not preferable.

Otherwise, in the present disclosure, as the body 100 of an anodic oxidation film material is wet-etched to form the vertical through parts 130, it is possible to make the width of each vertical connection part 210 equal to or less than 10 μm. However, when the width of each vertical connection part 210 is too small, resistance to current flowing along the coil unit 200 increases, so the width is preferably formed equal to or greater than 1 μm.

Furthermore, in the case of the body 100 made of an anodic oxidation film material, the anodic oxidation film is wet-etched to form the vertical through parts 130, so the vertical through parts 130 may have a section of a shape other than a circular section. The horizontal connection part 230 has a predetermined height and a section thereof has a quadrangular sectional shape. Since the vertical connection parts 210 may be manufactured such that vertical sections are quadrangular sections by using wet etching, the horizontal connection parts 230 and the vertical connection parts 210 may be provided to have the same widths, and the horizontal connection parts 230 and the vertical connection parts 210 may have the same sectional areas. In an aspect of current flowing along the coil unit 200, a stable current flow may be secured when the vertical connection parts 210 and the horizontal connection parts 230 are formed with the same areas, which is preferable. Therefore, when the body 100 is made of an anodic oxidation film material, it is possible to form the vertical connection parts 210 and the horizontal connection parts 230 with the same widths or areas, and a stable current flow may be secured.

As described above, when the plurality of first, second vertical through parts 131, 132 is formed through the upper part and the lower part of the body 100, the forming S20 of the vertical through parts is completed.

After the forming S20 of the vertical through parts is completed, the forming S30 of the vertical connection parts is performed.

As described in FIGS. 4a and 4b, in the forming S30 of the vertical connection parts, an electrically conductive material is filled in each first, second vertical through part 131, 132 to form each first, second vertical connection parts 211, 212.

The first, second vertical connection parts 211, 212 may be formed by filling the electrically conductive material into the first, second vertical through parts 131, 132 by using a plating method, an indentation method, etc.

When the plurality of first, second vertical through parts 131, 132 is filled with the electrically conductive material to form the plurality of first, second vertical connection parts 211, 212, the forming S30 of the vertical connection parts is completed.

After the forming S30 of the vertical connection parts is finished, the forming S50 of the horizontal connection part is performed.

As shown in FIGS. 5a and 5b, the forming S50 of the horizontal connection part is performed by forming the plurality of first horizontal connection parts 231 connecting the upper surfaces of the first vertical connection parts 211 to the upper surfaces of the plurality of second vertical connection parts 212 above the body 100, forming the plurality of second horizontal connection parts 232 connecting the lower surfaces of the plurality of first vertical connection parts 211 to the lower surfaces of the plurality of second vertical connection parts 212 below the body 100, and forming the first, second pad part 251, 252 on the upper surface of the body 100.

The first horizontal connection parts 231, the first pad part 251, and the second pad part 252 may be formed on the upper surface of the body 100 by using a known metal patterning method.

The second horizontal connection parts 232 may be formed on the lower surface of the body 100 by using a known metal patterning method.

Each first horizontal connection part 231 connects the upper surface of one of the plurality of first vertical connection parts 211 to the upper surface of one in the front side of the body 100 of second vertical connection parts in the minimum distance of the plurality of second vertical connection parts 212. Therefore, the plurality of first horizontal connection parts 231 is provided in a diagonal line that has rightward-upward inclination based on FIGS. 1 and 6a.

Therefore, the plurality of first horizontal connection parts 231 may have the inclination of the same angle.

A first horizontal connection part 231 located at the frontmost position of the body 100 among the plurality of first horizontal connection parts 231 connects the upper surface of the first vertical connection part 211 to the first pad part 251 formed on the upper surface of the body 100. In other words, among the plurality of first horizontal connection parts 231, one first horizontal connection part 231 located at the frontmost position in the body 100 is connected only to the upper surface of a first vertical connection part 211 and is not connected to the upper surface of a second vertical connection part 212.

Among the plurality of first horizontal connection parts 231, one first horizontal connection part 231 located at the rearmost position in the body 100 connects the second pad part 252 formed on the upper surface of the body 100 to the upper surface of a second vertical connection part 212. In other words, among the plurality of first horizontal connection parts 231, one first horizontal connection part 231 located at the rearmost position in the body 100 is connected only to the upper surface of a second vertical connection part 21s and is not connected to the upper surface of a first vertical connection part 211.

Each second horizontal connection part 232 connects the lower surface of one of the plurality of first vertical connection parts 211 to the lower surface of one in the rear side of the body 100 of second vertical connection parts in the minimum distance of the plurality of second vertical connection parts 212. Therefore, the second horizontal connection parts 232 are provided in diagonal lines having the leftward-upward inclination based on FIGS. 1 and 6a.

Therefore, the plurality of second horizontal connection parts 232 may have the inclination of the same angle.

The first vertical connection parts 211, the second vertical connection parts 212, the first horizontal connection parts 231, and the second horizontal connection parts 232 constitute the winding part 201, and the first pad part 251 and the second pad part 252 constitute the pad part 250.

As described above, the first horizontal connection parts 231, the second horizontal connection parts 232, the first pad part 251, and the second pad part 252 are formed in the body 100, completing the forming S50 of the horizontal connection part.

After the forming S50 of the horizontal connection part is completed, the forming S60 of the through hole is performed.

As described in FIGS. 6a and 6b, the forming S60 of the through hole is performed by forming the through hole 150 penetrating through the upper and lower surfaces of the body 100 to be located inside the plurality of first, second vertical connection parts 211, 212.

The through hole 150 may be formed through the upper surface and the lower surface of the body 100 by being wet-etched using a photoresist that is patterned in the body 100. The through hole 150 may be formed with a quadrangular shape.

The through hole 150 may be formed at the center portion of the body 100 so that the center point of the through hole 150 matches with the center point of the body 100.

The through hole 150 is located inside the plurality of vertical connection parts 210, i.e., inside the first vertical connection parts 211 and the second vertical connection parts 212.

The through hole 150 is located between the first vertical connection parts 211 and the second vertical connection parts 212.

As the through hole 150 is formed, some of the first horizontal connection parts 231 cross an upper part of the through hole 150, and some of the second horizontal connection parts 232 cross a lower part of the through hole 150. Therefore, the through hole 150 is located inside the winding part 201.

As described above, the through hole 150 is formed, completing the forming S60 of the through hole.

The inductor 10 according to the first embodiment of the present disclosure includes the coil unit 200, so that the inductor should not react sensitively to surrounding temperature and be deformed. The body 100 constituting the inductor 10 according to the first embodiment of the present disclosure consists of an anodic oxidation film material, so that thermal deformation of the inductor 10 can be minimized. As a result, fracture of the coil unit 200 or change of inductance can be prevented.

Furthermore, the method for manufacturing the inductor 10 according to the first embodiment of the present disclosure forms the coil unit 200 through the body 100 of an anodic oxidation film material by using wet-etching, patterning, etc., simplifying the manufacturing process and allowing mass production of the inductor 10.

### Inductor 10a According to Second Embodiment of Present Disclosure and Method for Manufacturing Inductor 10a

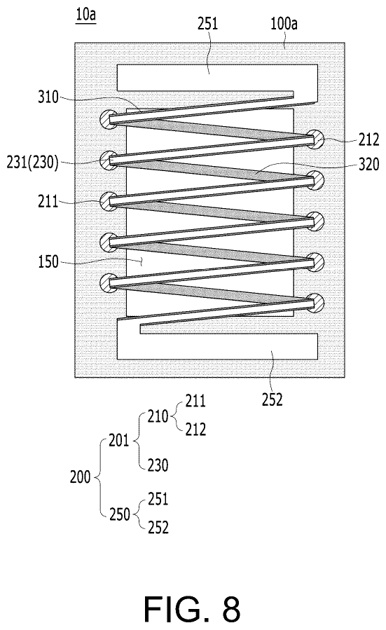

Hereinbelow, an inductor 10a according to the first embodiment of the present disclosure and a method for manufacturing the inductor 10a will be described with reference to FIGS. 8 to 15.

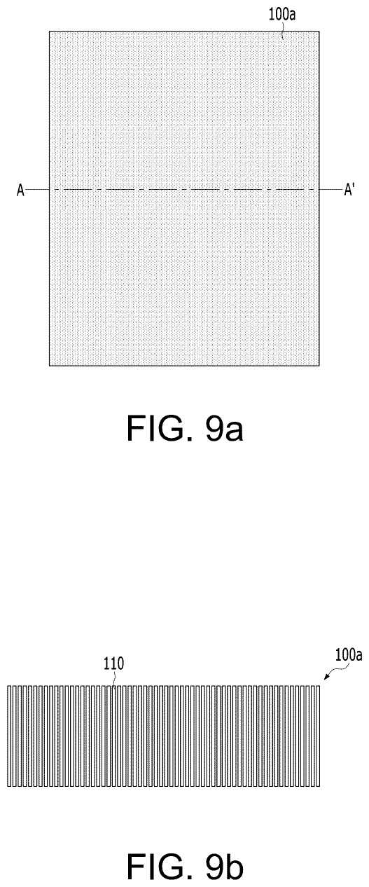

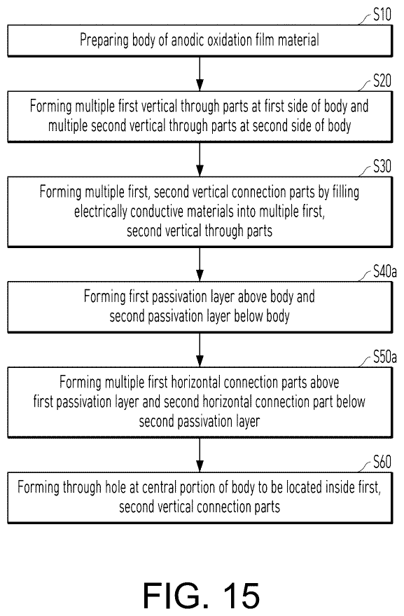

FIG. 8 is a view showing an inductor according to a second embodiment of the present disclosure. FIGS. 9a to 14b are views showing a manufacturing process of the inductor according to the second embodiment of the present disclosure. FIG. 15 is a schematic diagram showing the manufacturing process of the inductor according to the second embodiment of the present disclosure.

In the plan views of FIGS. 8, 9a, 10a, 11a, 12a, 13a, and 14a, an upward direction is the front side of the inductor 10a, and a downward direction is the rear side of the inductor 10a.

Referring to FIGS. 8 to 14b, the inductor 10a according to the second embodiment of the present disclosure may include: a body 100a of an anodic oxidation film material; a coil unit 200 including a plurality of vertical connection parts 210 formed through the body 100 and a horizontal connection part 230 connecting one to another of the plurality of the vertical connection parts 210; a plurality of passivation layers 300 supporting a plurality of horizontal connection parts 230; and a through hole 150 formed through upper and lower surfaces of the body to be located inside the plurality of vertical connection parts 210.

The inductor 10a according to the second embodiment of the present disclosure different from the inductor 10 according to the first embodiment of the present disclosure in that it includes a passivation layer 300, but the remaining components are the same. Therefore, descriptions of the same components are omitted.

The passivation layer 300 may include: a first passivation layer 310 located above the through hole 150 and below each first horizontal connection part 231 to support each horizontal connection part 231; and a second passivation layer 320 located below the through hole 150 and above each second horizontal connection part 232 to support each second horizontal connection part 232.

The passivation layer 300, i.e., the first passivation layer 310 and the second passivation layer 320 may be made of an insulating material.

The first passivation layer 310 may include a plurality of first passivation layers 310 in the same number as the plurality of first horizontal connection parts 231.

The plurality of first passivation layers 310 is located respectively below the plurality of first horizontal connection parts 231.

In other words, the plurality of first passivation layers 310 is located above the through hole 150, and the plurality of first horizontal connection parts 231 is located respectively above the plurality of first passivation layers 310. Therefore, the plurality of first passivation layers 310 is interposed between the through hole 150 and the plurality of first horizontal connection parts 231 and supports the plurality of first horizontal connection parts 231, respectively.

The plurality of first passivation layers 310 is located respectively below the plurality of first horizontal connection parts 231, so the plurality of plurality of first passivation layers 310 may be provided in diagonal lines having a rightward-upward inclination based on FIG. 8.

The plurality of first passivation layers 310 has a form that crosses the through hole 150 above the through hole 150 along with the plurality of first horizontal connection parts 231.

For the first horizontal connection parts 231 to easily connect the upper surfaces of the first vertical connection parts 211 to the upper surfaces of the second vertical connection parts 212, each first passivation layer 310 is not provided at a connection point between the upper surface of each first vertical connection part 211 and the first end of each first horizontal connection part 231 and a connection point between the upper surface of each second vertical connection part 212 and the second end of each first horizontal connection part 231. Therefore, the connection point between the upper surface of each first vertical connection part 211 and the first end of each first horizontal connection part 231 protrudes downwards from the first end of the first horizontal connection part 231 by a thickness of the first passivation layer 310, so that the first end of each first horizontal connection part 231 and the upper surface of each first vertical connection part 211 may be easily connected to each other. Furthermore, the connection point between the upper surface of each first vertical connection part 211 and the second end of each first horizontal connection part 231 protrudes downward from the second end of the first horizontal connection part 231 by a thickness of each first passivation layer 310, so that the second end of each first horizontal connection part 231 and the upper surface of each second vertical connection part 212 may be easily connected to each other.

The second passivation layer 320 may include a plurality of second passivation layers 320 in the same number as the plurality of second horizontal connection parts 232.

The plurality of second passivation layers 320 is located respectively below the plurality of second horizontal connection parts 232.

In other words, the plurality of second passivation layers 320 is located below the through hole 150, and the plurality of second horizontal connection parts 232 is located respectively below the plurality of second passivation layers 320. Therefore, the plurality of second passivation layers 320 is interposed between the through hole 150 and the plurality of second horizontal connection parts 232 and supports the plurality of second horizontal connection parts 232, respectively.

The plurality of second passivation layers 320 is located respectively below the plurality of second horizontal connection parts 232, so the plurality of plurality of second passivation layers 320 may be provided in diagonal lines having a leftward-upward inclination based on FIG. 8.

The plurality of second passivation layers 320 has a form that crosses the through hole 150 above the through hole 150 along with the plurality of second horizontal connection parts 232.

For the second horizontal connection parts 232 to easily connect the lower surfaces of the first vertical connection parts 211 to the lower surfaces of the second vertical connection parts 212, each second passivation layer 320 is not provided at a connection point between the lower surface of each first vertical connection part 211 and the first end of each second horizontal connection part 232 and a connection point between the lower surface of each second vertical connection part 212 and the second end of each second horizontal connection part 232. Therefore, the connection point between the lower surface of each first vertical connection part 211 and the first end of each second horizontal connection part 232 protrudes upwards from the first end of the second horizontal connection part 232 by a thickness of the second passivation layer 320, so that the first end of each second horizontal connection part 232 and the lower surface of each first vertical connection part 211 may be easily connected to each other. Furthermore, the connection point between the lower surface of each first vertical connection part 211 and the second end of each second horizontal connection part 232 protrudes upwards from the second end of the second horizontal connection part 232 by a thickness of each second passivation layer 320, so that the second end of each second horizontal connection part 232 and the lower surface of each second vertical connection part 212 may be easily connected to each other.

Hereinbelow, a method for manufacturing the inductor 10a according to the second embodiment of the present disclosure will be described.

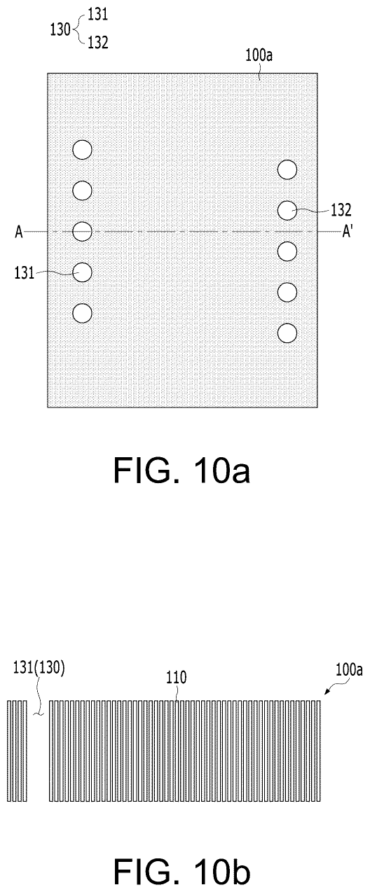

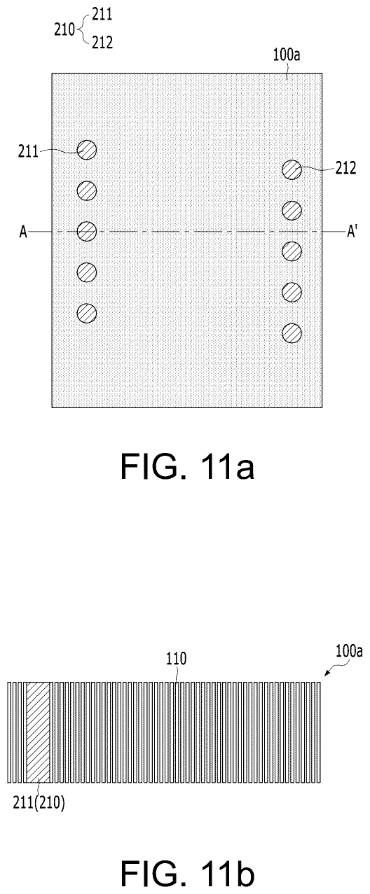

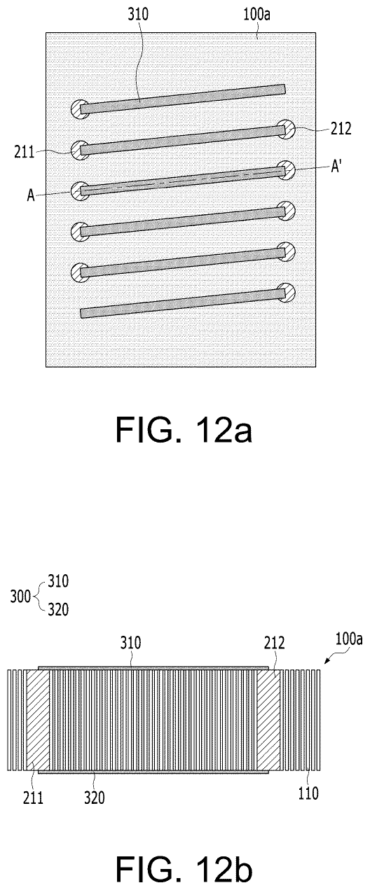

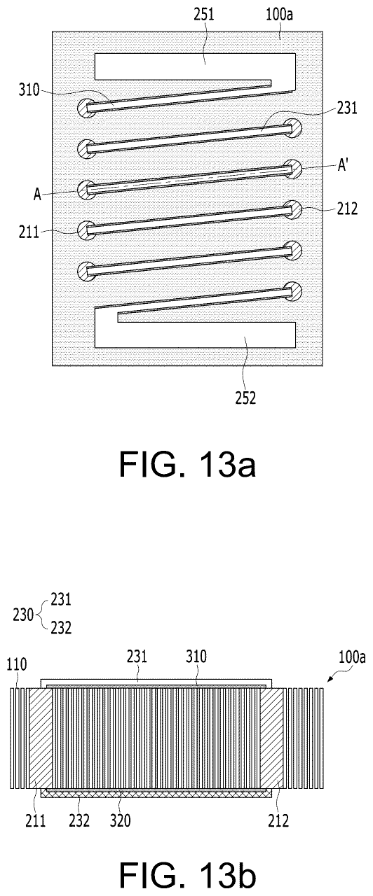

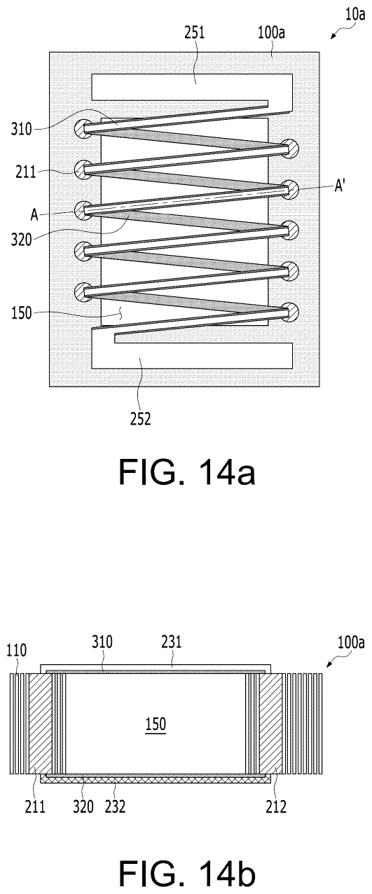

FIG. 9a is a plan view of the body of an anodic oxidation film material. FIG. 9b is a sectional view of the body, which is taken along the line A-A′ of FIG. 9a. FIG. 10a is a plan view of the body in which the first and second vertical through parts are formed. FIG. 10b is a sectional view of the body, which is taken along the line A-A′ of FIG. 10a. FIG. 11a is a plan view of the body in which the first and second vertical connection parts are formed. FIG. 11b is a sectional view of the body, which is taken along the line A-A′ of FIG. 11a. FIG. 12a is a plan view of the body in which the first and second passivation layers are formed. FIG. 12b is a sectional view of the body, which is taken along line A-A′ FIG. 12a. FIG. 13a is a plan view of the body in which the first and second horizontal connection parts and the first and second pad parts are formed. FIG. 13b is a sectional view of the body, which is taken along the line A-A′ of FIG. 13a. FIG. 14a is a plan view of the body in which the through hole is formed. FIG. 14b is a sectional view of the body, which is taken along the line A-A′ of FIG. 14a.

As shown in FIGS. 8 to 15, the method for manufacturing the inductor 10a according to the second embodiment of the present disclosure may include: preparing the body 100a of an anodic oxidation film material, S10; forming the vertical through parts S20, in which the plurality of first vertical through parts 131 is formed at a first side of the body 100a and through the upper and lower surfaces of the body 100a and arranged in a column direction, and the plurality of second vertical through parts 132 is formed at a second part of the body 100a and through the upper and lower surfaces of the body 100a and arranged in a column direction; forming the vertical connection parts S30, in which the plurality of first, second vertical through parts 131, 132 is filled with an electroconductive material to form the plurality of first, second vertical connection parts 211, 212; forming passivation layers S40a by forming the plurality of first passivation layers 310 above the body 100a and the plurality of second passivation layers 320 below the body 100a; forming the horizontal connection parts S50a, in which the plurality of first horizontal connection parts 231 is formed to be located above the body 100a and connect the upper surfaces of the plurality of first vertical connection parts 211 to the upper surfaces of the plurality of second vertical connection parts 212 and located respectively above the plurality of first passivation layers 310, and the plurality of second horizontal connection parts 232 is formed to be located below the body 100a and connect the lower surfaces of the plurality of first vertical connection parts 211 to the lower surfaces of the plurality of second vertical connection parts 212 and located respectively below the plurality of second passivation layers 320; and forming the through hole S60, in which the through hole 150 is formed through the upper and lower surfaces of the body 100a to be located inside the plurality of first, second vertical connection parts 211, 212.

The method for manufacturing the inductor 10a according to the second embodiment of the present disclosure is different from the inductor 10 according to the first embodiment of the present disclosure in that it includes the forming S40a of passivation layers, but the remaining components are the same. Therefore, descriptions of the same components are omitted.

As described above FIGS. 9a and 9b, in the preparing of the body S10, the process of preparing the body 100a of an anodic oxidation film material is performed.

After the preparing S10 is completed, the forming S20 of the vertical through parts is formed.

As shown in FIGS. 10a and 10b, the forming S20 of the vertical through parts is performed by forming the plurality of first vertical through parts 131 provided at the first part of the body 100a and formed through the upper and lower surfaces of the body 100a and arranged in the column direction, and forming the plurality of second vertical through parts 132 provided at the second part of the body 100a and formed through the upper and lower surfaces of the body 100a and arranged in the column direction.

After the forming S20 of the vertical through parts is completed, the forming S30 of the vertical connection parts is performed.

As described in FIGS. 11a and 11b, in the forming S30 of the vertical connection parts, an electrically conductive material is filled in each first, second vertical through part 131, 132 to form each first, second vertical connection parts 211, 212.

After the forming S30 of the vertical connection parts is finished, the forming S40a of the passivation layer is performed.

As shown in FIGS. 12a and 12b, in the forming S40a of the passivation layer, a process, in which the plurality of first passivation layers 310 is formed at the upper portion of the body 100a and the plurality of second passivation layers 320 is formed at the lower portion of the body 100a, is performed.

The passivation layer 300, i.e., the first passivation layers 310 may be formed on the upper surface of the body 100a by using a known metal patterning method, and the second passivation layers 320 may be formed on the lower surface of the body 100a by using the known metal patterning method.

To support each first horizontal connection part 231, each first passivation layer 310 may be formed in a direction connecting one of the plurality of first vertical connection parts 211 to a second vertical connection part 212 located at front of the body 100a of second vertical connection parts 212 in the minimum distance among the plurality of second vertical connection parts 212 on the upper surface of the body 100a. Therefore, the number of and inclination of the plurality of first passivation layers 310 are formed equal to the plurality of first horizontal connection parts 231.

Since the first passivation layers 310 do not need to directly connect the upper surfaces of the first vertical connection parts 211 and the upper surfaces of the second vertical connection parts 212, the first passivation layers 310 may connect or not connect the upper surfaces of the first vertical connection parts 211 and the upper surfaces of the second vertical connection parts 212 to each other.

The plurality of first passivation layers 310 is provided in a diagonal line having a rightward-upward inclination based on FIGS. 8 and 12a.

The plurality of first passivation layers 310 may have the inclination of the same angle.

The frontmost first passivation layer 310 of the plurality of first passivation layers 310 is not formed in a direction toward a second vertical connection part 212, but is formed from a first vertical connection part 211 in a direction toward the first pad part 251 formed in the forming S50a of the horizontal connection part.

The rearmost first passivation layer 310 of the plurality of first passivation layers 310 is not formed from a first vertical connection part 211 in a direction toward a second vertical connection part 212, but is formed from the second pad part 252 formed in the forming S50a of the horizontal connection part in a direction toward a first vertical connection part 211.

To support each second horizontal connection part 232, each second passivation layer 320 may be formed in a direction connecting one of the plurality of first vertical connection parts 211 to a second vertical connection part 212 located at rear of the body 100a of second vertical connection parts 212 in the minimum distance among the plurality of second vertical connection parts 212 on the upper surface of the body 100a. Therefore, the number of and inclination of the plurality of second passivation layers 320 are formed equal to the plurality of second horizontal connection parts 232.

Since the second passivation layers 320 do not need to directly connect the lower surfaces of the first vertical connection parts 211 and the lower surfaces of the second vertical connection parts 212, the second passivation layers 320 may connect or not connect the lower surfaces of the first vertical connection parts 211 and the lower surfaces of the second vertical connection parts 212 to each other.

The plurality of second passivation layers 320 is provided in a diagonal line having a leftward-upward inclination based on FIGS. 8 and 12a.

The plurality of second passivation layers 320 may have the inclination of the same angle.

As described above, when the plurality of first passivation layers 310 and the plurality of second passivation layers 320 are formed, the forming S40a of the passivation layers is completed.

After the forming S40a of the passivation layers is completed, the forming S50a of the horizontal connection part is performed.

As shown in FIGS. 13a and 13b, in the forming S50a of the horizontal connection part, the upper surfaces of the plurality of first vertical connection parts 211 and the upper surfaces of the plurality of second vertical connection parts 212 are connected to each other on the upper portion of the body 100a, the plurality of first horizontal connection parts 231 located at the upper portions of the plurality of first passivation layers 310 is formed, the plurality of second horizontal connection parts 232 connecting the lower surfaces of the plurality of first vertical connection parts 211 to the lower surfaces of the plurality of second vertical connection parts 212 on the lower portion of the body 100a, and located at the lower portions of the plurality of second passivation layers 320 is formed, and the first, second pad part 251, 252 is formed on the upper surface of the body 100a.

To locate the plurality of first horizontal connection parts 231 on the upper portions of the plurality of first passivation layers 310, the plurality of first horizontal connection parts 231 is formed on the upper surfaces of the first passivation layers 310, the upper surfaces of the first vertical connection parts 211, and the upper surfaces of the second vertical connection parts 212 by using a known metal patterning method.

A first end of each first horizontal connection part 231 protrudes downward by a thickness of each first passivation layer 310, and the first end of each first horizontal connection part 231 and the upper surface of each first vertical connection part 211 are connected to each other.

A second end of each first horizontal connection part 231 protrudes downward by a thickness of each first passivation layer 310, and the second end of each first horizontal connection part 231 and the upper surface of each second vertical connection part 212 are connected to each other.

The first pad part 251 and the second pad part 252 may be formed on the upper surface of the body 100a by using a known metal patterning method.

A first horizontal connection part 231 located at the frontmost position of the body 100a among the plurality of first horizontal connection parts 231 connects the upper surface of the first vertical connection part 211 to the first pad part 251 formed on the upper surface of the body 100a. In other words, among the plurality of first horizontal connection parts 231, one first horizontal connection part 231 located at the frontmost position in the body 100a is connected only to the upper surface of each first vertical connection part 211, and is not connected to the upper surface of each second vertical connection part 212.

Among the plurality of first horizontal connection parts 231, one first horizontal connection part 231 located at the rearmost position in the body 100a connects the second pad part 252 formed on the upper surface of the body 100a to the upper surface of each second vertical connection part 212. In other words, among the plurality of first horizontal connection parts 231, one first horizontal connection part 231 located at the rearmost position in the body 100a is connected only to the upper surface of each second vertical connection part 212 and is not connected to the upper surface of each first vertical connection part 211.

To locate the plurality of second horizontal connection parts 232 on the lower portions of the plurality of second passivation layers 320, the plurality of second horizontal connection parts 232 is formed on the lower surfaces of the second passivation layers 320, the lower surfaces of the first vertical connection parts 211, and the lower surfaces of the second vertical connection parts 212 by using a known metal patterning method.

A first end of each second horizontal connection part 232 protrudes upward by a thickness of each second passivation layer 320, and the first end of each second horizontal connection part 232 and the lower surface of each first vertical connection part 211 are connected to each other.

The plurality of second horizontal connection parts 232 and the plurality of second passivation layers 320 may have inclinations at the same angle.

A second end of each second horizontal connection part 232 protrudes upward by a thickness of each second passivation layer 320, and the second end of each second horizontal connection part 232 and the lower surface of each second vertical connection part 212 are connected to each other.

The plurality of second horizontal connection parts 232 and the plurality of second passivation layers 320 may have inclinations at the same angle.

As described above, the first horizontal connection parts 231, the second horizontal connection parts 232, the first pad part 251, and the second pad part 252 are formed in the body 100a, completing the forming S50 of the horizontal connection part.

After the forming S50 of the horizontal connection part is completed, the forming S60 of the through hole is performed.

As described in FIGS. 14a and 14b, the forming S60 of the through hole is performed by forming the through hole 150 penetrating through the upper and lower surfaces of the body 100a to be located inside the plurality of first, second vertical connection parts 211, 212.

As the through hole 150 is formed, some of the first horizontal connection parts 231 and some of the first passivation layers 310 cross an upper part of the through hole 150, and some of the second horizontal connection parts 232 and some of the second passivation layers 320 cross a lower part of the through hole 150. Therefore, the through hole 150 is located inside the winding part 201.

As described above, the through hole 150 is formed, completing the forming S60 of the through hole.

According to the second embodiment of the present disclosure, the inductor 10a may prevent the coil unit 200 from being damaged by damage to the first horizontal connection parts 231 and the second horizontal connection parts 232 as the first passivation layer 310 supports the first horizontal connection parts 231 and the second passivation layer 320 supports the second horizontal connection parts 232.

### Inductor 10b according to a third embodiment of the present disclosure and method for manufacturing inductor 10b

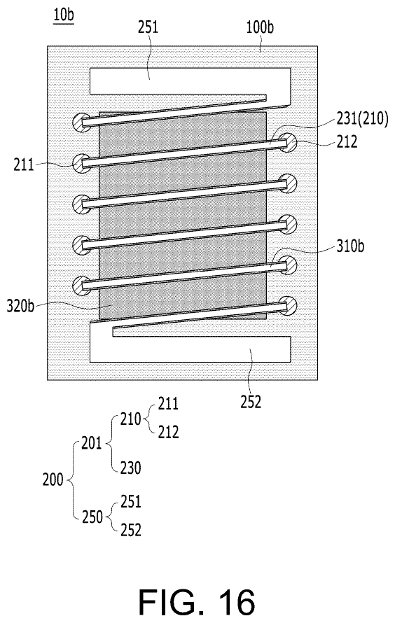

Hereinbelow, an inductor 10b according to the third embodiment of the present disclosure and a method for manufacturing the inductor 10b will be described with reference to FIGS. 16 to 23.

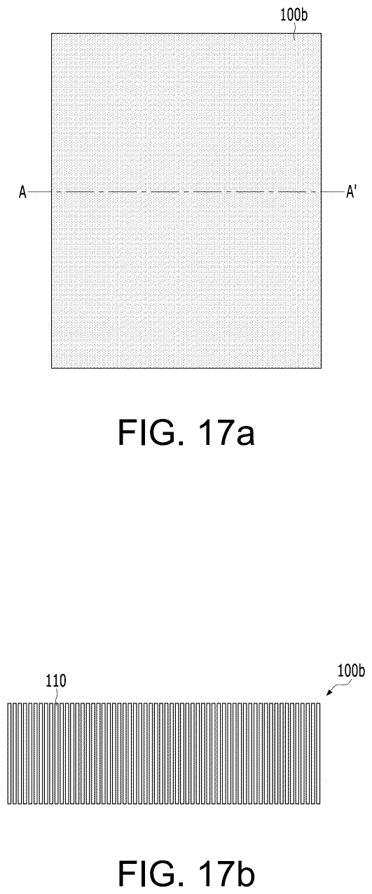

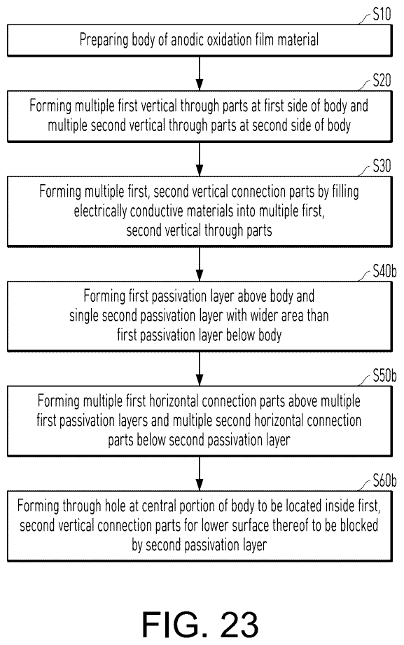

FIG. 16 is a view showing an inductor according to a third embodiment of the present disclosure. FIGS. 17a to 22b are views showing a manufacturing process of the inductor according to the third embodiment of the present disclosure. FIG. 23 is a schematic diagram showing the manufacturing process of the inductor according to the third embodiment of the present disclosure.

In the plan views of FIGS. 16, 17a, 18a, 19a, 20a, 21a, and 22a, an upward direction is the front side of the inductor 10b, and a downward direction is the rear side of the inductor 10b.

As shown in FIGS. 16 to 22b, the inductor 10b according to the third embodiment of the present disclosure may include: a body 100b of an anodic oxidation film material; the coil unit 200 including the plurality of vertical connection parts 210 passing through the body 100b and the horizontal connection part 230 connecting one of the plurality of vertical connection parts 210 to another; a passivation layer 300b supporting the horizontal connection part 230; and the through hole 150 formed through the upper and lower surfaces of the body to be located inside the plurality of vertical connection parts 210. The plurality of vertical connection parts 210 may include the plurality of first vertical connection parts 211 and the plurality of second vertical connection parts 212. The plurality of horizontal connection part 230 may include the plurality of first horizontal connection parts 231 and the plurality of second horizontal connection parts 232. The passivation layer 300b may include a plurality of first passivation layers 310b respectively supporting the plurality of first horizontal connection parts 231 and a second passivation layer 320b supporting the second horizontal connection parts 232.

The inductor 10b according to the third embodiment of the present disclosure is different in the shape of the second passivation layer 320b in comparison to the above-described inductor 10a according to the second embodiment of the present disclosure and the remaining components thereof are identical to the inductor 10a. Therefore, descriptions of the same components are omitted.

The passivation layer 300b may include: the plurality of first passivation layers 310b located above the through hole 150 and below the plurality of first horizontal connection parts 231 to support the plurality of horizontal connection parts 231; and the single second passivation layer 320b located below the through hole 150 and above the plurality of second horizontal connection parts 232 to support the plurality of second horizontal connection parts 232.

The passivation layer 300b, i.e., each first passivation layer 310b and each second passivation layer 320 may be made of an insulating material.

The first passivation layer 310b may include a plurality of first passivation layers 310b in the same number as the plurality of first horizontal connection parts 231.

The plurality of first passivation layers 310b is located respectively below the plurality of first horizontal connection parts 231.

In other words, the plurality of first passivation layers 310b is located above the through hole 150, and the plurality of first horizontal connection parts 231 is located respectively above the plurality of first passivation layers 310b. Therefore, the plurality of first passivation layers 310b is interposed between the through hole 150 and the plurality of first horizontal connection parts 231 and supports the plurality of first horizontal connection parts 231, respectively.

The plurality of first passivation layers 310b is located respectively below the plurality of first horizontal connection parts 231, so the plurality of plurality of first passivation layers 310b may be provided in diagonal lines having a rightward-upward inclination based on FIG. 8.

The plurality of first passivation layers 310b has a form that crosses the through hole 150 above the through hole 150 along with the plurality of first horizontal connection parts 231.

For the first horizontal connection parts 231 to easily connect the upper surfaces of the first vertical connection parts 211 to the upper surfaces of the second vertical connection parts 212, each first passivation layer 310b is not provided at a connection point between the upper surface of each first vertical connection part 211 and the first end of each first horizontal connection part 231 and a connection point between the upper surface of each second vertical connection part 212 and the second end of each first horizontal connection part 231. Therefore, the connection point between the upper surface of each first vertical connection part 211 and the first end of each first horizontal connection part 231 protrudes downwards from the first end of the first horizontal connection part 231 by a thickness of each first passivation layer 310b, so that the first end of each first horizontal connection part 231 and the upper surface of each first vertical connection part 211 may be easily connected to each other. Furthermore, the connection point between the upper surface of each first vertical connection part 211 and the second end of each first horizontal connection part 231 protrudes downward from the second end of the first horizontal connection part 231 by a thickness of each first passivation layer 310b, so that the second end of each first horizontal connection part 231 and the upper surface of each second vertical connection part 212 may be easily connected to each other.

The single second passivation layer 320b is formed to have an area wider than an area of the through hole 150 to block a lower portion of the through hole 150, and is located above the plurality of second horizontal connection parts 232.

The second passivation layer 320b supports the second horizontal connection parts 232 above the second horizontal connection parts 232.

The second passivation layer 320b is located below the through hole 150 to block the lower portion of the through hole 150, and the plurality of second horizontal connection parts 232 is located below the single second passivation layer 320b. Therefore, the second passivation layer 320b is interposed between the through hole 150 and the plurality of second horizontal connection parts 232 and supports the plurality of second horizontal connection parts 232.

For the second horizontal connection parts 232 to easily connect the lower surfaces of the first vertical connection parts 211 to the lower surfaces of the second vertical connection parts 212, the second passivation layer 320b is not provided at a connection point between the lower surface of each first vertical connection part 211 and the first end of each second horizontal connection part 232 and a connection point between the lower surface of each second vertical connection part 212 and the second end of each second horizontal connection part 232. Therefore, the connection point between the lower surface of each first vertical connection part 211 and the first end of each second horizontal connection part 232 protrudes upwards from the first end of the second horizontal connection part 232 by a thickness of the second passivation layer 320b, so that the first end of each second horizontal connection part 232 and the lower surface of each first vertical connection part 211 may be easily connected to each other. Furthermore, the connection point between the lower surface of each first vertical connection part 211 and the second end of each second horizontal connection part 232 protrudes upwards from the second end of the second horizontal connection part 232 by a thickness of the second passivation layer 320b, so that the second end of each second horizontal connection part 232 and the lower surface of each second vertical connection part 212 may be easily connected to each other.

Hereinbelow, a method for manufacturing the inductor 10b according to the third embodiment of the present disclosure will be described.

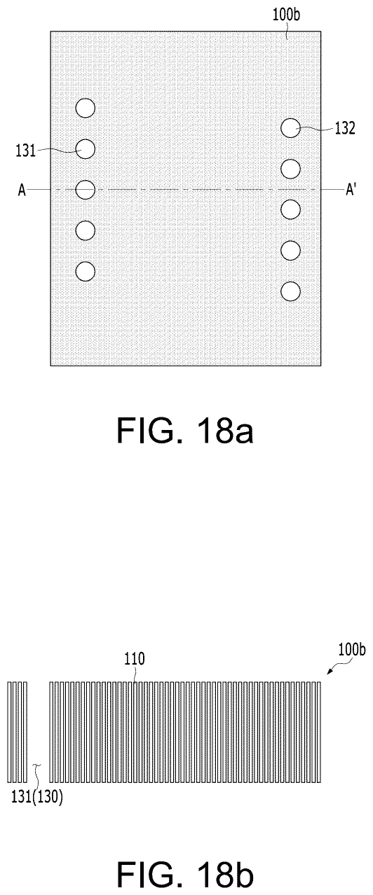

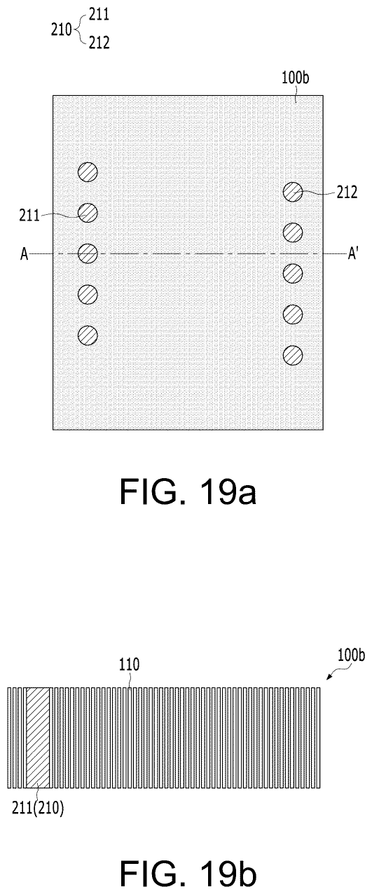

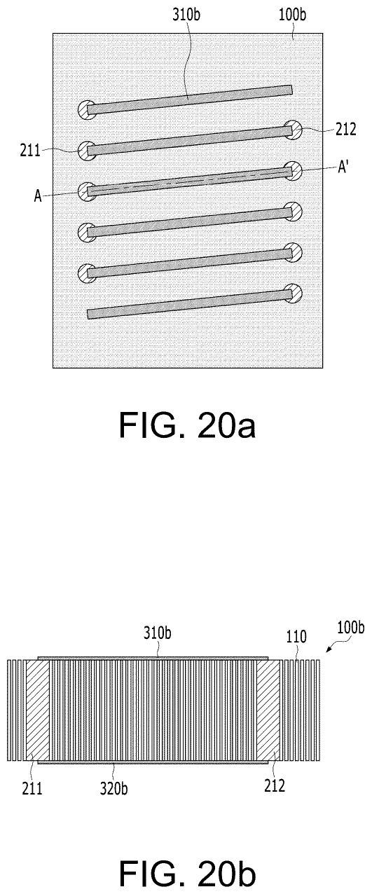

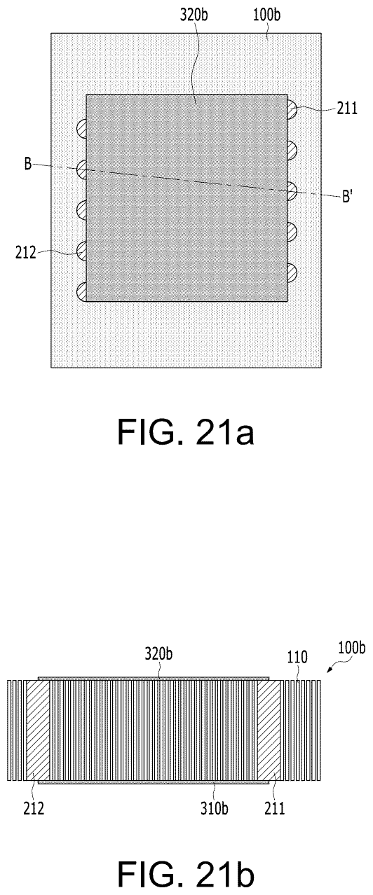

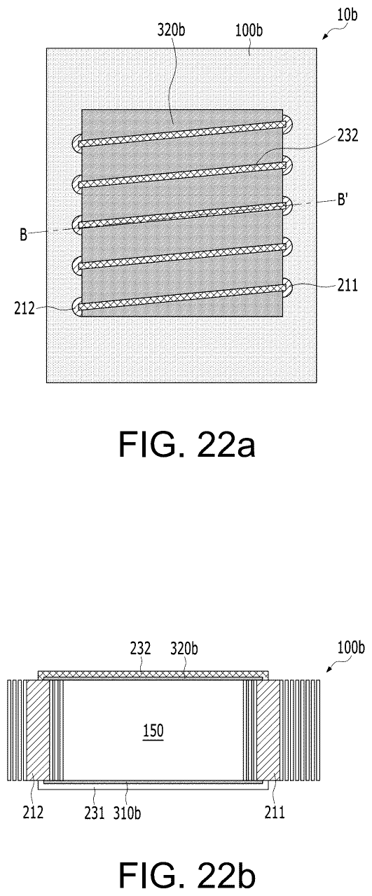

FIG. 17a is a plan view illustrating the body of an anodic oxidation film material. FIG. 17b is a sectional view illustrating the body, the view being taken along line A-A′ of FIG. 17a. FIG. 18a is a plan view illustrating the body with the first and second vertical through parts formed. FIG. 18b is a sectional view illustrating the body, the view being taken along line A-A′ of FIG. 18a. FIG. 19a is a plan view illustrating the body with the first and second vertical connection parts formed. FIG. 19b is a sectional view illustrating the body, the view being taken along line A-A′ of FIG. 19a. FIG. 20a is a plan view illustrating the body with the first and passivation layers formed. FIG. 20b is a sectional view illustrating the body, the view being taken along line A-A′ of FIG. 20a. FIG. 21a is a bottom view illustrating the body with the second passivation layer is formed. FIG. 21b is a sectional view illustrating the body, the view being taken along line B-B′ of FIG. 21a. FIG. 22a is a bottom view illustrating the body with the first and second horizontal connection parts and the pad part formed. FIG. 22b is a sectional view illustrating the body, the view being taken along line B-B′ of FIG. 22a. FIG. 23 is a schematic view illustrating the method for manufacturing the inductor according to the third embodiment of the present disclosure.

As shown in FIGS. 16 to 23, the method for manufacturing the inductor 10b according to the third embodiment of the present disclosure may include: preparing the body 100b of an anodic oxidation film material, S10; forming the vertical through parts S20, in which the plurality of first vertical through parts 131 is formed at a first side of the body 100b and through the upper and lower surfaces of the body 100b and arranged in a column direction, and the plurality of second vertical through parts 132 is formed at a second part of the body 100b and through the upper and lower surfaces of the body 100b and arranged in a column direction; forming the vertical connection parts S30, in which the plurality of first, second vertical through parts 131, 132 is filled with an electroconductive material to form the plurality of first, second vertical connection parts 211, 212; forming passivation layers S40b by forming the plurality of first passivation layers 310b above the body 100b and the single passivation layer 320b below the body 100b; forming the horizontal connection parts S50b, in which the plurality of first horizontal connection parts 231 is formed to be located above the body 100b and connect the upper surfaces of the plurality of first vertical connection parts 211 to the upper surfaces of the plurality of second vertical connection parts 212 and located respectively above the plurality of first passivation layers 310b, and the plurality of second horizontal connection parts 232 is formed to be located below the body 100b and connect the lower surfaces of the plurality of first vertical connection parts 211 to the lower surfaces of the plurality of second vertical connection parts 212 and located below the second passivation layer 320; and forming the through hole S60, in which the through hole 150 is formed through the upper and lower surfaces of the body 100b to be located inside the plurality of first, second vertical connection parts 211, 212.

The method for manufacturing the inductor 10b according to the third embodiment of the present disclosure is different in formation of the passivation layer formed in the forming S40b of the passivation layer in comparison to the method for manufacturing the inductor 10b according to the second embodiment of the present disclosure. Therefore, descriptions of the same components are omitted.

As described above FIGS. 17a and 17b, in the preparing of the body S10, the process of preparing the body 100b of an anodic oxidation film material is performed.

After the preparing S10 is completed, the forming S20 of the vertical through parts is formed.

As shown in FIGS. 18a and 18b, the forming S20 of the vertical through parts is performed by forming the plurality of first vertical through parts 131 provided at the first part of the body 100b and formed through the upper and lower surfaces of the body 100b and arranged in the column direction, and forming the plurality of second vertical through parts 132 provided at the second part of the body 100b and formed through the upper and lower surfaces of the body 100b and arranged in the column direction.

After the forming S20 of the vertical through parts is completed, the forming S30 of the vertical connection parts is performed.

As described in FIGS. 19a and 19b, in the forming S30 of the vertical connection parts, an electrically conductive material is filled in each first, second vertical through part 131, 132 to form each first, second vertical connection parts 211, 212.

After the forming S30 of the vertical connection parts is finished, the forming S40b of the passivation layer is performed.

As shown in FIGS. 20a to 21b, in the forming S40b of the passivation layer, the plurality of first passivation layers 310b is formed above the body 100b, and the single second passivation layer 320b having the area wider than the area of the first passivation layer 310b is formed below the body 100b.

The passivation layer 300b, i.e., the first passivation layer 310b may be formed on the upper surface of the body 100b by using a known metal patterning method, and the second passivation layer 320b may be formed on the lower surface of the body 100b by using the known metal patterning method.

To support each first horizontal connection part 231, each first passivation layer 310b may be formed in a direction connecting one of the plurality of first vertical connection parts 211 to a second vertical connection part 212 located at front of the body 100b of second vertical connection parts 212 in the minimum distance among the plurality of second vertical connection parts 212 on the upper surface of the body 100b. Therefore, the number of and inclination of the plurality of first passivation layers 310b are formed equal to the plurality of first horizontal connection parts 231.

Since the first passivation layers 310b do not need to directly connect the upper surfaces of the first vertical connection parts 211 and the upper surfaces of the second vertical connection parts 212, the first passivation layers 310 may connect or not connect the upper surfaces of the first vertical connection parts 211 and the upper surfaces of the second vertical connection parts 212 to each other.

The plurality of first passivation layers 310b is provided in a diagonal line having a rightward-upward inclination based on FIG. 16.

The plurality of first passivation layers 310b may have the inclination of the same angle.

The frontmost first passivation layer 310b of the plurality of first passivation layers 310b is not formed in a direction toward a second vertical connection part 212, but is formed from a first vertical connection part 211 in a direction toward the first pad part 251 formed in the forming S50b of the horizontal connection part.

The rearmost first passivation layer 310b of the plurality of first passivation layers 310b is not formed from a first vertical connection part 211 in a direction toward a second vertical connection part 212, but is formed from the second pad part 252 formed in the forming S50b of the horizontal connection part in a direction toward a first vertical connection part 211.

The second passivation layer 320b is formed by patterning on the lower surface of the body 100b to have the area wider than the area of the through hole 150 formed in the forming S60 of the through hole.

The single second passivation layer 320b supports the plurality of second horizontal connection parts 212.

Since the second passivation layer 320b does not need to directly connect the lower surfaces of the first vertical connection parts 211 and the lower surfaces of the second vertical connection parts 212, the second passivation layer 320b may connect or not connect the lower surfaces of the first vertical connection parts 211 and the lower surfaces of the second vertical connection parts 212 to each other.

As described above, when the plurality of first passivation layers 310b and the second passivation layer 320b are formed, the forming S40b of the passivation layers is completed.

After the forming S40b of the passivation layers is completed, the forming S50b of the horizontal connection part is performed.

As shown in FIGS. 16, 22a, and 22b, in the forming S50b of the horizontal connection part, the upper surfaces of the plurality of first vertical connection parts 211 and the upper surfaces of the plurality of second vertical connection parts 212 are connected to each other on the upper portion of the body 100b, the plurality of first horizontal connection parts 231 located at the upper portions of the plurality of first passivation layers 310b is formed, the plurality of second horizontal connection parts 232 connecting the lower surfaces of the plurality of first vertical connection parts 211 to the lower surfaces of the plurality of second vertical connection parts 212 on the lower portion of the body 100b, and located at the lower portion of the second passivation layer 320b is formed, and the first, second pad part 251, 252 is formed on the upper surface of the body 100b.

To locate the plurality of first horizontal connection parts 231 on the upper portions of the plurality of first passivation layers 310b, the plurality of first horizontal connection parts 231 is formed on the upper surfaces of the first passivation layers 310b, the upper surfaces of the first vertical connection parts 211, and the upper surfaces of the second vertical connection parts 212 by using a known metal patterning method.

A first end of each first horizontal connection part 231 protrudes downward by a thickness of each first passivation layer 310b, and the first end of each first horizontal connection part 231 and the upper surface of each first vertical connection part 211 are connected to each other.

A second end of each first horizontal connection part 231 protrudes downward by a thickness of each first passivation layer 310b, and the second end of each first horizontal connection part 231 and the upper surface of each second vertical connection part 212 are connected to each other.

The first pad part 251 and the second pad part 252 may be formed on the upper surface of the body 100b by using a known metal patterning method.

A first horizontal connection part 231 located at the frontmost position of the body 100b among the plurality of first horizontal connection parts 231 connects the upper surface of the first vertical connection part 211 to the first pad part 251 formed on the upper surface of the body 100b.

In other words, among the plurality of first horizontal connection parts 231, one first horizontal connection part 231 located at the frontmost position in the body 100b is connected only to the upper surface of each first vertical connection part 211, and is not connected to the upper surface of each second vertical connection part 212.

Among the plurality of first horizontal connection parts 231, one first horizontal connection part 231 located at the rearmost position in the body 100b connects the second pad part 252 formed on the upper surface of the body 100b to the upper surface of each second vertical connection part 212. In other words, among the plurality of first horizontal connection parts 231, one first horizontal connection part 231 located at the rearmost position in the body 100b is connected only to the upper surface of each second vertical connection part 212 and is not connected to the upper surface of each first vertical connection part 211.

To locate the plurality of second horizontal connection parts 232 on the lower portion of the single second passivation layer 320, the plurality of second horizontal connection parts 232 is formed on the lower surfaces of the second passivation layer 320b, the lower surfaces of the first vertical connection parts 211, and the lower surfaces of the second vertical connection parts 212 by using a known metal patterning method.

A first end of each second horizontal connection part 232 protrudes upward by a thickness of the second passivation layer 320b, and the first end of each second horizontal connection part 232 and the lower surface of each first vertical connection part 211 are connected to each other.

Therefore, the plurality of second horizontal connection parts 232 may have the inclination of the same angle.

A second end of each second horizontal connection part 232 protrudes upward by a thickness of the second passivation layer 320b, and the second end of each second horizontal connection part 232 and the lower surface of each second vertical connection part 212 are connected to each other.

As described above, the first horizontal connection parts 231, the second horizontal connection parts 232, the first pad part 251, and the second pad part 252 are formed in the body 100b completing the forming S50 of the horizontal connection part.

After the forming S50b of the horizontal connection part is completed, the forming S60 of the through hole is performed.

As described in FIGS. 22a and 22b, the forming S60 of the through hole is performed by forming the through hole 150 penetrating through the upper and lower surfaces of the body 100b to be located inside the plurality of first, second vertical connection parts 211, 212.

With the formation of the through hole 150, a part of the first horizontal connection part 231 and a part of the first passivation layer 310b cross the upper part of the through hole 150.

Since the area of the second passivation layer 320b is wider than the area of the through hole 150, even when the through hole 150 is formed, the lower part of the through hole 150 is blocked.

The through hole 150 is located inside the winding part 201.

As described above, the through hole 150 is formed, completing the forming S60 of the through hole.

According to the third embodiment of the present disclosure, the inductor 10b may prevent the coil unit 200 from being damaged by damage to the first horizontal connection parts 231 and the second horizontal connection parts 232 as the first passivation layer 310b supports the first horizontal connection parts 231 and the second passivation layer 320b supports the second horizontal connection parts 232.

Furthermore, since the second passivation layer 320b airtightly blocks the lower part of the through hole 150, air may be efficiently filled inside the through hole 150, and a high quality factor of the inductor 10b can be secured due to low dielectric permittivity.

### Inductor 10c According to a Fourth Embodiment of the Present Disclosure and Method for Manufacturing Inductor 10c

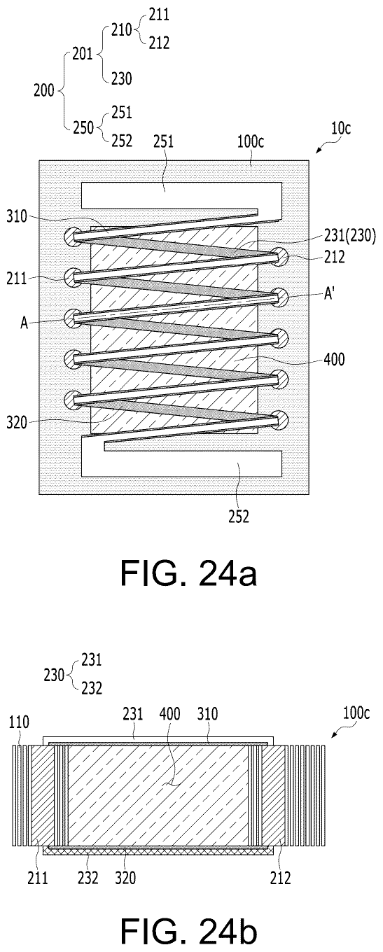

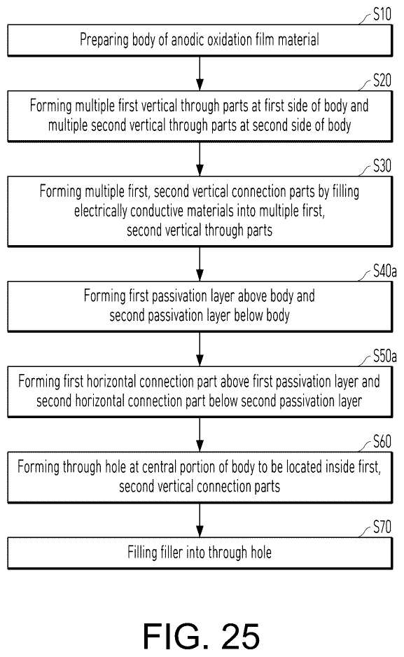

Hereinbelow, an inductor 10c according to the fourth embodiment of the present disclosure and a method for manufacturing the inductor 10c will be described with reference to FIGS. 24a to 25.

FIG. 24a is a plan view of the inductor according to the fourth embodiment of the present disclosure. FIG. 24b is a sectional view of the inductor according to the fourth embodiment of the present disclosure, which is taken along line A-A′ in FIG. 24a. FIG. 25 is a schematic view of a method for manufacturing the inductor according to the fourth embodiment of the present disclosure.

In the plan view of FIG. 24a, an upward direction is the front side of the inductor 10c, and a downward direction is the rear side of the inductor 10c.

Referring to FIGS. 24a to 24b, the inductor 10c according to the fourth embodiment of the present disclosure may include a body 100c of an anodic oxidation film material; a coil unit 200 including a plurality of vertical connection parts 210 formed through the body 100c and a horizontal connection part 230 connecting one to another of the plurality of the vertical connection parts 210; the plurality of passivation layers 300 supporting a plurality of horizontal connection parts 230; a through hole (not given with reference numeral) formed through upper and lower surfaces of the body to be located inside the plurality of vertical connection parts 210; and a filler 400 filled inside the through hole.

The inductor 10c according to the fourth embodiment of the present disclosure is different in that the filler 400 is filled inside the through hole in comparison to the above-described inductor 10a according to the second embodiment of the present disclosure and the remaining components thereof are identical to the inductor 10a. Therefore, descriptions of the same components are omitted.

The filler 400 is filled inside the through hole.

Since the filler 400 is provided inside the through hole, the filler 400 is provided between the first and second vertical connection parts 211, 212, and between the first and second horizontal connection parts 231, 232 and the first and second passivation layers 310, 320. In other words, the filler 400 is provided inside the coil unit 200.

The first passivation layer 310 and the first horizontal connection parts 231 cross the upper part of the filler 400, and the second passivation layer 320 and the second horizontal connection parts 232 cross the lower part of the filler 400.

The filler 400 may be a low dielectric permittivity material having a 4 or less dielectric permittivity.

For example, the filler 400 may be made of a low dielectric permittivity material among silicon dioxide (SiO2), cyclic clefin polymer (COP), fluorinated silicon oxide (SiOF), polyimides, parylene, fluorinated parylene, benzocyclobutene, and Teflon.

The filler 400 may be made of a high permeable magnetic material.

For example, the filler 400 may be made of a magnetic material such as ferrite, etc.

Hereinbelow, a method for manufacturing the inductor 10c according to the fourth embodiment of the present disclosure will be described.

As shown in FIGS. 24a to 25, the method for manufacturing the inductor 10c according to the fourth embodiment of the present disclosure may include: preparing the body 100c of an anodic oxidation film material, S10; forming the vertical through parts S20, in which the plurality of first vertical through parts 131 is formed at a first side of the body 100c and through the upper and lower surfaces of the body 100c and arranged in a column direction, and the plurality of second vertical through parts 132 is formed at a second part of the body 100c and through the upper and lower surfaces of the body 100c and arranged in a column direction; forming the vertical connection parts S30, in which the plurality of first, second vertical through parts 131, 132 is filled with an electroconductive material to form the plurality of first, second vertical connection parts 211, 212; forming passivation layers S40a by forming the plurality of first passivation layers 310 above the body 100c and the plurality of second passivation layers 320 below the body 100c; forming the horizontal connection parts S50a, in which the plurality of first horizontal connection parts 231 is formed to be located above the body 100c and connect the upper surfaces of the plurality of first vertical connection parts 211 to the upper surfaces of the plurality of second vertical connection parts 212 and located respectively above the plurality of first passivation layers 310, and the plurality of second horizontal connection parts 232 is formed to be located below the body 100c and connect the lower surfaces of the plurality of first vertical connection parts 211 to the lower surfaces of the plurality of second vertical connection parts 212 and located respectively below the plurality of second passivation layers 320; forming the through hole S60, in which the through hole is formed through the upper and lower surfaces of the body 100c to be located inside the plurality of first, second vertical connection parts 211, 212; and filling the filler 400 into the through hole, S70.

The method for manufacturing the inductor 10c according to the fourth embodiment of the present disclosure is different from the inductor 10a according to the second embodiment of the present disclosure in that it includes the filling S70 of the filler, but the remaining components are the same. Therefore, descriptions of the same components are omitted.

After the forming S60 of the through hole, the filling S70 of the filler is performed.

In the filling S70 of the filler, filling the filler 400 into the through hole is performed.

In the filling S70 of the filler, the filler 400 may be filled inside the through hole by using a plating method, an indentation method, etc.

When the filler 400 is filled in the through hole, the filling S70 of the filler is completed.

### Inductor 10d According to a Fifth Embodiment of the Present Disclosure and Method for Manufacturing Inductor 10d

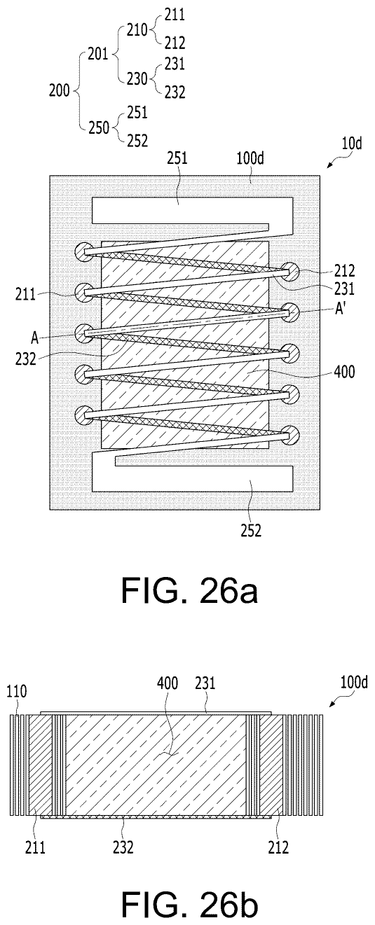

Hereinbelow, an inductor 10d according to the fifth embodiment of the present disclosure and a method for manufacturing the inductor 10d will be described with reference to FIGS. 26a to 26b.

FIG. 26a is a plan view illustrating the inductor according to the fifth embodiment of the present disclosure. FIG. 26b is a sectional view illustrating the inductor according to the fifth embodiment of the present disclosure, which is taken along line A-A′ of FIG. 26a.

Referring to FIGS. 26a to 26b, the inductor 10b according to the fifth embodiment of the present disclosure may include the body 100d of an anodic oxidation film material; the coil unit 200 including the plurality of vertical connection parts 210 formed through the body 100d and the horizontal connection part 230 connecting one to another of the plurality of the vertical connection parts 210; the through hole (not given with reference numeral) formed through the upper and lower surfaces of the body to be located inside the plurality of vertical connection parts 210; and the filler 400 filled inside the through hole.

The inductor 10d according to the fifth embodiment of the present disclosure is different in that the filler 400 is filled inside the through hole in comparison to the above-described inductor 10 according to the first embodiment of the present disclosure and the remaining components thereof are identical to the inductor 10.

The filler 400 is filled inside the through hole.

The filler 400 may be a low dielectric permittivity material having a 4 or less dielectric permittivity.

For example, the filler 400 may be made of a low dielectric permittivity material among silicon dioxide (SiO2), cyclic clefin polymer (COP), fluorinated silicon oxide (SiOF), polyimides, parylene, fluorinated parylene, benzocyclobutene, and Teflon.

The filler 400 may be made of a high permeable magnetic material.

For example, the filler 400 may be made of a magnetic material such as ferrite, etc.

Since the filler 400 is provided inside the through hole, the filler 400 is provided between the first and second vertical connection parts 211, 212, and between the first and second horizontal connection parts 231, 232. In other words, the filler 400 is provided inside the coil unit 200.

The first horizontal connection parts 231 cross the upper part of the filler 400, and the second horizontal connection parts 232 cross the lower part of the filler 400.

The method for manufacturing the inductor 10d according to the fifth embodiment of the present disclosure is different from the inductor 10 according to the first embodiment of the present disclosure in that it includes the filling S70 of the filler, but the remaining components are the same.

Therefore, the method for manufacturing the inductor 10d according to the fifth embodiment of the present disclosure may include: preparing the body 100d of an anodic oxidation film material, S10; forming the vertical through parts S20, in which the plurality of first vertical through parts 131 is formed at a first side of the body 100d and through the upper and lower surfaces of the body 100d and arranged in a column direction, and the plurality of second vertical through parts 132 is formed at a second part of the body 100d and through the upper and lower surfaces of the body 100d and arranged in a column direction; forming the vertical connection parts S30, in which the plurality of first, second vertical through parts 131, 132 is filled with an electroconductive material to form the plurality of first, second vertical connection parts 211, 212; forming the horizontal connection parts S50, in which the plurality of first horizontal connection parts 231 is formed to be located above the body 100d and connect the upper surfaces of the plurality of first vertical connection parts 211 to the upper surfaces of the plurality of second vertical connection parts 212, and the plurality of second horizontal connection parts 232 is formed to be located below the body 100d and connect the lower surfaces of the plurality of first vertical connection parts 211 to the lower surfaces of the plurality of second vertical connection parts 212; forming the through hole S60, in which the through hole 150 is formed through the upper and lower surfaces of the body 100d to be located inside the plurality of first, second vertical connection parts 211, 212; and filling the filler 400 into the through hole, S70.

The description of the filling S70 of the filler has been performed, and it will be omitted.

In the inductor 10c according to the fourth embodiment of the present disclosure and the inductor 10d according to the fifth embodiment, when the filler 400 is made of a low dielectric permittivity material such as silicon oxide (SiO2) described above, the filler 400 made of a low dielectric permittivity material having a low dielectric permittivity is provided inside the coil unit 200, and thus the inductor may have a high quality factor value in a high frequency. Therefore, in the inductor 10c according to the fourth embodiment of the present disclosure and the inductor 10d according to the fifth embodiment, the inductor may have a high quality factor value by the filler 400 of a low dielectric permittivity provided in the through hole.

In the inductor 10c according to the fourth embodiment of the present disclosure and the inductor 10d according to the fifth embodiment, when the filler 400 is made of a high permeable magnetic material such as a magnetic material described above, the filler 400 made of a low dielectric permittivity material having a high magnetic permeability is provided inside the coil unit 200, and thus the inductor may have a high inductance. Therefore, in the inductor 10c according to the fourth embodiment of the present disclosure and the inductor 10d according to the fifth embodiment, the inductor may have a high inductance value by the filler 400 of a high magnetic permeability provided in the through hole.

As described above, depending on a material constituting the filler 400 inside the through hole, the inductor 10c according to the fourth embodiment of the present disclosure and the inductor 10d according to the fifth embodiment may have a high quality factor in a high frequency (when the filler 400 is made of a low dielectric permittivity material), and have a high inductance of high capacity (when the filler 400 is made of a high permeable magnetic material).

Although not illustrated in the drawings, the through hole 150 the inductor 10b according to the third embodiment of the present disclosure may be filled with the filler. In this case, the filler may be made of a low dielectric permittivity material having a 4 or less dielectric permittivity or a high permeable magnetic such as a magnetic material.

Although the preferred embodiments of the present disclosure have been described for illustrative purposes, those skilled in the art will appreciate that various modifications, additions and substitutions are possible, without departing from the scope and spirit of the present disclosure as disclosed in the accompanying claims.

### DESCRIPTION OF REFERENCE NUMERALS

10, 10a, 10b, 10c, 10d: inductor
100, 100a, 100b, 100c, 100d: body
110: pore
130: vertical through part
131: first vertical through part
132: second vertical through part
150: through hole
200: coil unit
201: winding part
210: vertical connection part
211: first vertical connection part
212: second vertical connection part
230: horizontal connection part
231: first horizontal connection part
232: second horizontal connection part
250: pad part
251: first pad part
252: second pad part
300: passivation layer
310, 310b: first passivation layer
320, 320b: second passivation layer
400: filler

What is claimed is:

1. An inductor comprising:
a body of an anodic oxidation film material;
a coil unit comprising a plurality of vertical connection parts passing through the body, and horizontal connection parts connecting the plurality of vertical connection parts; and
a through hole formed through an upper surface and a lower surface of the body to be located inside the plurality of vertical connection parts.

2. The inductor of claim 1, wherein the horizontal connection parts comprise:
first horizontal connection parts provided above the body and connecting upper surfaces of the plurality of vertical connection parts to each other; and
second horizontal connection parts provided below the body and connecting lower surfaces of the plurality of vertical connection parts to each other, and
the through hole is located between the first and second horizontal connection parts.

3. The inductor of claim 2, further comprises;
a first passivation layer located above the through hole and below each first horizontal connection part to support each first horizontal connection part; and
a second passivation layer located below the through hole and above each second horizontal connection part to support each second horizontal connection part.

4. The inductor of claim 3, wherein the first passivation layer comprises a plurality of first passivation layers as the same number as the number of the plurality of first horizontal connection parts, and the plurality of first passivation layers is located respectively below the plurality of first horizontal connection parts, and
the second passivation layer is formed to have an area wider than an area of the through hole to block a lower portion of the through hole and is located above the plurality of second horizontal connection parts.

5. The inductor of claim 1, wherein the vertical connection parts comprise:
first vertical connection parts arranged in a column direction at a first part of the body; and
second vertical connection parts arranged in the column direction at a second part of the body, and
when the first vertical connection parts are projected toward the second vertical connection parts, the first vertical connection parts are located between the second vertical connection parts.

6. The inductor of claim 4, wherein each of the horizontal connection parts connects one of the plurality of the first vertical connection parts to one of the second vertical connection parts, the second vertical connection part being located at a minimum distance.

7. The inductor of claim 1, further comprising:
a filler of a low dielectric permittivity material, the filler being filled inside the through hole.

8. The inductor of claim 1, further comprising:
a filler of a high permeable magnetic material, the filler being filled inside the through hole.

9. A method for manufacturing an inductor, the method comprising:
preparing a body of an anodic oxidation film material;
forming vertical through parts, wherein a plurality of first vertical through parts is formed at a first side of the body and formed through upper and lower surfaces of the body and arranged in a column direction, and a plurality of second vertical through parts is formed at a second side of the body and formed through the upper and lower surfaces of the body and arranged in the column direction;
forming vertical connection parts, wherein electrically conductive materials are filled into the plurality of first vertical through parts and the plurality of second vertical through parts to form a plurality of first vertical connection parts and a plurality of second vertical connection parts;
forming horizontal connection parts, wherein a plurality of first horizontal connection parts is formed above the body and connect upper surfaces of the plurality of first vertical connection parts to upper surfaces of the plurality of second vertical connection parts, and a plurality of second horizontal connection parts is formed below the body and connect lower surfaces of the plurality of first vertical connection parts and lower surfaces of the plurality of second vertical connection parts; and
forming a through hole, wherein the through hole is formed through the upper and lower surfaces of the body to be located inside the first and second vertical connection parts.

10. The method of claim 8, further comprising:
forming passivation layers, before the forming of the first and second horizontal connection parts, wherein a first passivation layer is formed above the body and a second passivation layer is formed below the body,
wherein in the forming of the horizontal connection parts, each first horizontal connection part is formed above the first passivation layer, and each second horizontal connection part is formed below the second passivation layer.

11. The method of claim 8, further comprising:
filling a filler inside the through hole, after the forming of the through hole.
